(19) United States
(12) Patent Application Publication
(10) Pub. No.: US 2026/0134309 A1
(43) Pub. Date: May 14, 2026

(54) DYNAMIC COGNITIVE CONTEXT SYSTEMS, METHODS, AND APPARATUSES

(71) Applicant: Beyond AGI LLC, Austin, TX (US)

(72) Inventors: Pavel Jacko, Westbeemster (NL); Marko Lehtimäki, Hyllykallio (FI); Harri S. Sarsa, Berlin (DE)

(21) Appl. No.: 19/386,318

(22) Filed: Nov. 12, 2025

Related U.S. Application Data
(60) Provisional application No. 63/719,187, filed on Nov. 12, 2024.
(60) Provisional application No. 63/723,570, filed on Nov. 21, 2024.

(51) Int. Cl. G06N 5/04; G06F 40/30; G06N 5/022

(52) U.S. Cl. CPC G06N 5/04; G06F 40/30; G06N 5/022

(57) ABSTRACT

The present disclosure sets forth systems, apparatuses, and methods that uniquely combine vector-based semantic processing with graph-based knowledge representations, leveraging the strengths of both approaches to improve similarity searches and context matching and capture nuanced semantic relationships between concepts. The disclosed systems, apparatuses, and methods include components configured to receive data, determine based on the data one or more entities, and generate, based on the one or more entities, a probability distribution, context associated with the data, and historical interactions, one or more semantic mappings comprising nodes interconnected according to weighted relationships, and update, based on at least one of additional data, context, or interactions, the one or more semantic mappings.

### CROSS REFERENCE TO RELATED APPLICATIONS

This patent claims priority to and the benefit of U.S. Provisional Patent Application No. 63/719,187, filed on Nov. 12, 2024, entitled “Dynamic Cognitive Context System,” and U.S. Provisional Patent Application No. 63/723,570, filed on Nov. 21, 2024, entitled “Dynamic Cognitive Context System.” U.S. Provisional Patent Application No. 63/719,187 and U.S. Provisional Patent Application No. 63/723,570 are hereby incorporated herein by reference in their entireties.

### FIELD OF THE DISCLOSURE

This disclosure relates generally to dynamic cognitive context systems, apparatuses, and methods for use with artificial intelligence systems, inference engines, and other computational systems requiring contextual information.

### BACKGROUND

Current artificial intelligence (AI) implementations—such as large language models (LLMs) in the form of virtual assistants or chatbots, retrieval systems, search engines, and knowledge management systems—have numerous capabilities but often struggle with contextual understanding. While additional information may be added based on user queries—within a context window—these systems often have limited context window sizes, for which only parts of the conversation or data within the context window may be considered when retrieving information. Current techniques attempting to improve information retrieval based on context—such as retrieval-augmented generation (RAG) approaches including memory-based retrieval and graph knowledge bases—require exponentially increased computational resources and costs.

### BRIEF DESCRIPTION OF THE DRAWINGS

FIG. 1 is a perspective view of an example network architecture comprising a cognitive neural network and an executable neural network that form a dynamic cognitive context system in accordance with teachings of this disclosure.

FIG. 2 is a perspective view of an example operational topology showing cognitive nodes, execution nodes, and connections, illustrating signal flow in accordance with teachings of this disclosure.

FIG. 3 is a block diagram of an example dynamic cognitive context system in accordance with teachings of this disclosure.

FIG. 4 is a block diagram of an example implementation of the dynamic cognitive context system of FIG. 3 in accordance with teachings of this disclosure.

FIG. 5 is a block diagram of an example entity processing system in accordance with teachings of this disclosure.

FIG. 6 is a block diagram of an example entity storage system in accordance with teachings of this disclosure.

FIG. 7 is a block diagram of an example cognitive processing system in accordance with teachings of this disclosure.

FIG. 8 is a block diagram of an example cognitive storage system in accordance with teachings of this disclosure.

FIGS. 9A-9E are block diagrams illustrating Cognitive Graphs comprising meaning nodes and relationship edges in accordance with teachings of this disclosure.

FIGS. 10A-10C are timing diagrams illustrating an example contextualization process in accordance with teachings of this disclosure.

FIG. 11 is a flowchart illustrating an entification process in accordance with teachings of this disclosure.

FIGS. 12A-12C are block diagrams illustrating exemplary node and/or relationship weighting as part of the example contextualization process of FIGS. 10A-10C in accordance with teachings of this disclosure.

FIG. 13 is a block diagram illustrating an example confidence scoring process in accordance with teachings of this disclosure.

FIG. 14 is a block diagram illustrating an example context pruning process in accordance with teachings of this disclosure.

FIG. 15 is a block diagram illustrating an example validation feedback loop in accordance with teachings of this disclosure.

FIG. 16 is a block diagram of a computing device used in accordance with the teachings of this disclosure.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

### Overview of Context in AI Systems

In the rapidly evolving field of artificial intelligence, large language models have emerged as powerful tools capable of generating textual content in a human-like manner. Some of these models, such as GPT, Gemini, and Claude, have found applications in diverse domains ranging from customer service and creative writing to scientific research and legal analysis. However, the efficacy of large language models and other AI systems may be significantly influenced by the context provided to them as part of an input (e.g., user query). Context may provide background information that may guide a model or system in generating responses that are more relevant and accurate than those generated based on the model's or system's internal knowledge alone. Contextual information may ensure that language models and other systems understand not just the literal meaning of words or data but also the nuances, intentions, and situational specifics underlying a query or input. For example, the word “bank” may refer to a financial institution or the side of a river, and without context, a language model or system may misinterpret the intended meaning. By incorporating contextual cues, models and systems may be able to disambiguate such terms and provide responses that are aligned with the user's intent.

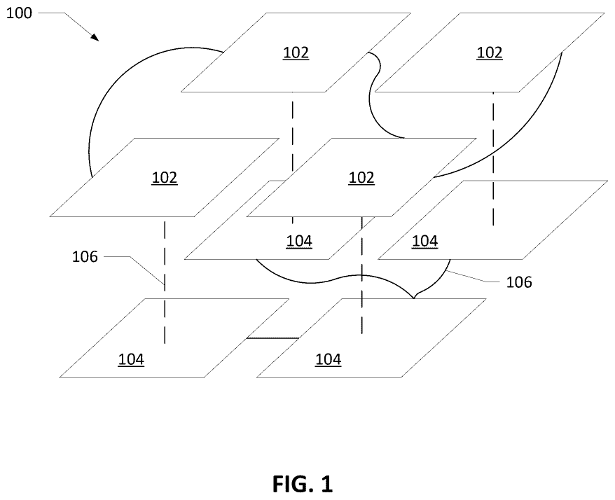

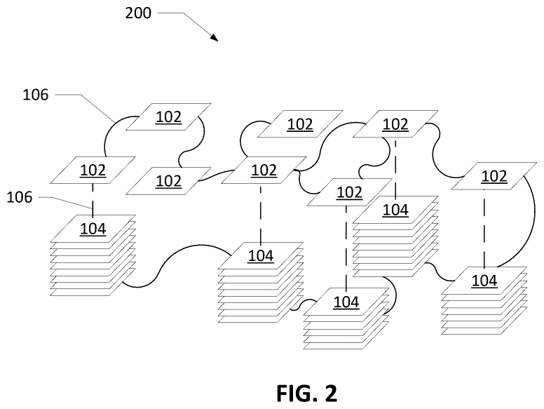

The present disclosure relates to implementing, among other things, non-deterministic considerations. In some examples, this may involve a network comprising neurons that may each be associated with a large language model. In accordance with the teachings of this disclosure, FIGS. 1-2 set forth perspective views of example networks 100, 200 comprising a number of neural nodes or instances in which dynamic cognitive context systems may be implemented. The exemplary illustrated neural nodes may be implemented via software as modules. In some examples, the exemplary neural nodes may be associated with corresponding hardware or portions of corresponding hardware. In some examples, each neural node may be associated with its own hardware. In some examples, the neural nodes may be implemented on a device, a system, a local area network of devices, a cloud-based network of devices, an Internet based network of devices, or any combination thereof. The networks 100, 200 may comprise one or more cognitive neural networks 102 and one or more executable neural networks 104. The cognitive neural network 102 and the executable neural network 104 may communicate via signals via one or more connections 106. In some examples, the cognitive neural network 102 may create relationships in meanings on the nodes of the networks 100, 200, which may enable the neural nodes to communicate efficiently and effectively. In some examples, the cognitive neural network 102 may adjust (e.g., enrich, reduce, or otherwise change) signals traveling between neurons, which may enable precise and relevant transmission of information. In some examples, the cognitive neural network 102 may provide timely contextualization for LLMs, which may enable neurons to better understand and respond to changing conditions. In some examples, the cognitive neural network 102 may rely on embeddings. The cognitive neural network 102 may enable long-term memory storage in a compact format.

In some examples, the executable neural network 104 may comprise a number of nodes that act as executable neurons within the networks 100, 200. In some examples, the nodes may act as neural logic gates, similar to AND, OR, NOT, NAND, NOR, XOR, and XNOR logic gates in digital circuits. In some examples, the nodes may comprise embeddings, API calls, and LLM GUIs (e.g., OllamaChat). In some examples, a node may communicate with an LLM at a synapse activator, during runtime, at an axion signal router, and/or during avion replication. The executable neural network 104 may control the structure of the networks 100, 200, including the creation, adjustment, or destruction of neurons. In order to create new neurons, the executable neural network 104 may comprise a neural blueprint including a collection of existing neurons to use as a reference or baseline for the creation of the new neurons.

In operation, the networks 100, 200 may be trained before and after deployment, in contrast to transformer-based models that can only be deployed after extensive training. The cognitive neural network 102 may enable the networks 100, 200 to process and interpret incoming data and make decisions based on that information. In some examples, the incoming data may be multimodal in that it may come from disparate types of sources (e.g., text, audio, imagery, video, or any combination thereof). In some examples, the incoming data may come from such disparate sources simultaneously and may or may not be related.

In an example implementation of the networks 100, 200, image data (e.g., photos and/or live/recorded video) and audio data relating to a child being severely burned by a flame from a stovetop may be received. The cognitive neural network 102 may develop a relationship between a node associated with fire and a node associated with injury. In some such examples, audio data relating to someone calling emergency services (e.g., an ambulance) may be subsequently received. In a similar manner, the cognitive neural network 102 may develop a relationship between the node associated with injury and a node associated with calling emergency services. These specific circumstances may enable the networks 100, 200 to, in response to receipt of subsequent sensory information indicating a house fire, to identify the potential dangerous circumstances associated with a house fire and, based on prior knowledge associating fire with the fire department (e.g., based on a prior association created by the cognitive neural network 102, based on internet data, based on pre-trained information) and based on location information, determine to alert the proper emergency service (e.g., the local fire department) to resolve the detected house fire. In a similar manner, the cognitive neural network 102 may determine that the house fire may cause injury, and recommend navigation to a safe location (e.g., outside of the house). And, any implemented actions (e.g., calling the local fire department and navigating to a safe location) may enable the cognitive neural network 102 to create even further relationships based on whether the determined actions taken were successful, unsuccessful, and to what degree. As such, the networks 100, 200 may always be adapting and improving based on its interactions with the environment.

The present disclosure sets forth additional contextualization improvements over existing AI implementations. In the rapidly evolving field of artificial intelligence, large language models have emerged as powerful tools capable of generating textual content in a human-like manner. Some of these models, such as GPT, Gemini, and Claude, have found applications in diverse domains ranging from customer service and creative writing to scientific research and legal analysis. However, the efficacy of large language models and other AI systems may be significantly influenced by the context provided to them as part of an input (e.g., query). Context may provide background information that may guide a model or system in generating responses that are more relevant and accurate than those generated based on the model's or system's internal knowledge alone. Contextual information may ensure that language models and other systems understand not just the literal meaning of words or data but also the nuances, intentions, and situational specifics underlying a query or input. For example, the word “bank” may refer to a financial institution or the side of a river, and without context, a language model or system may misinterpret the intended meaning. By incorporating contextual cues, models and systems may be able to disambiguate such terms and provide responses that are aligned with the user's intent.

Context may also enhance the personalization of interactions. In applications like virtual assistants, search engines, or recommendation systems, leveraging context such as previous interactions, preferences, and history may lead to more meaningful and satisfying experiences. Contextual awareness may allow systems to tailor responses that are not only accurate but also resonate with specific needs and expectations.

Beyond accuracy and relevance, context may enable large language models and other systems to emulate human-like cognition and emotional intelligence. Emotional understanding, empathy, and the ability to recognize subtle social cues may be useful in replicating human communication. By incorporating contextual information about emotional states, social dynamics, and cultural nuances, large language models and other systems can better mirror human-like responses. This emotional context may allow models and systems to detect sentiment, understand humor, recognize distress, and respond with appropriate levels of empathy. Achieving genuine emotional intelligence remains challenging, as it may involve not just pattern recognition, but also a deep understanding of human psychology and social behavior. The ability to maintain emotional consistency across interactions while adapting to changing emotional contexts may result in more natural and engaging human-AI interactions.

While static context may provide a baseline understanding, it may fall short in dynamic environments where information may change rapidly, or where queries may be highly specific and varied. In dynamic environments, context regeneration may be beneficial. Context regeneration may involve dynamically creating or updating context for each interaction based on the latest available data and the specifics of the query or input. By regenerating context in real-time, large language models and other systems may be able to adapt to new information, emerging trends, and individual behaviors. This adaptability may benefit scenarios such as live customer support, real-time data analysis, or interactive storytelling, where the relevance of information can shift from one moment to the next.

Context regeneration may also mitigate the limitations of relying solely on pre-existing context, which may become outdated or irrelevant. It may empower large language models and other systems to incorporate more pertinent information, thereby enhancing the accuracy and utility of the generated responses. In essence, context regeneration may enable large language models and other systems to be more responsive, intelligent, and effective in meeting the demands of complex, real-world applications. Recent attempts to advance AI towards more complex cognitive capabilities have involved leveraging prior user interactions, preferences, and history to supply additional context to queries and inputs. However, these attempts may often result in irrelevant or only partially relevant information retrieval, increased latency in retrieval, increased system complexity, increased resource requirements, scalability challenges, data privacy concerns, stale context, hallucinations, and increased expenses. Furthermore, these attempts fail to provide adaptability to highly specific or unforeseen queries and face difficulties in balancing precision with recall. This is because these recent attempts focus on contextual retrieval, not contextual regeneration. The disclosed systems, methods, and apparatuses may perform context regeneration, dynamically constructing new context in real-time, rather than context retrieval, which fetches pre-existing context from storage.

Additionally, complex cognitive systems exhibit context-dependent variability, where identical inputs may yield different responses based on current system state, recent history, attention, and goals. This adaptive non-determinism is functional rather than noise; it enables context-sensitive reasoning, creative problem-solving, and learning from interaction. The disclosed system supports such variability by dynamically updating semantic mappings and weights as context evolves.

As used herein, “weights” refer to multi-dimensional relationship strength values (rational, emotional, temporal dimensions) that represent the semantic connection strength between nodes in the Cognitive Graph. “Confidence scores” refer to quality and reliability assessments assigned to information, relationships, or interpretations, representing the trustworthiness of data or the likelihood of correctness. Weights and confidence scores are related but distinct: weights quantify relationship strength, while confidence scores assess quality and reliability.

### Limitations of Existing Contextual Retrieval Approaches

Contextual retrieval methods operate by fetching and recalling pre-existing information from stored repositories, databases, or memory systems. These approaches retrieve documents, past interactions, or knowledge graph entries that were previously created and stored, essentially looking backward to find relevant information. While this may provide access to established knowledge, retrieved context may quickly become stale, may lack specificity for novel queries, and may require significant computational resources to search through large repositories.

In contrast, contextual regeneration—the approach disclosed herein—fundamentally differs from retrieval by dynamically constructing new context in real-time rather than merely fetching pre-existing context. Contextual regeneration may synthesize new contextual understanding by actively processing semantic relationships, updating knowledge structures, and adapting to present circumstances. The disclosed systems, methods, and apparatuses may perform context regeneration to construct context dynamically from current inputs, emerging patterns, and evolving relationships, creating contextual understanding that did not exist prior to the query. This dynamic construction may enable systems to respond to unforeseen queries, maintain current relevance, and achieve precision without sacrificing completeness. In some examples, regeneration and retrieval may be fundamentally different operations, with regeneration creating new context and retrieval accessing existing context. This dynamic construction may allow systems to respond to unforeseen queries, maintain current relevance, and achieve precision without sacrificing completeness. The following examination of existing retrieval approaches illustrates why retrieval alone—regardless of specific implementation—may be insufficient for achieving true contextual intelligence.

Various approaches have been developed to address the challenges of contextual retrieval. While they offer valuable contributions, each has limitations that hinder their effectiveness in certain scenarios. One such approach is Retrieval-Augmented Generation (RAG), which combines information retrieval techniques with generation systems. RAG involves fetching relevant documents or data segments based on input and using this information to inform responses. In some examples, providing specific information retrieved from trusted sources may enhance accuracy and reduce the likelihood of hallucinations. RAG may allow systems to access the latest data, which may be crucial for time-sensitive queries. However, RAG systems may retrieve irrelevant or only partially relevant documents, such that additional filtering mechanisms may be required. RAG's retrieval process can introduce delays, which may affect real-time performance. Additionally, combining retrieval and generation components increases system complexity.

Another such approach is Memory-Based Retrieval, a type of RAG approach that may use stored information from previous interactions or sessions to provide context. Memory-Based Retrieval may leverage historical data to maintain continuity and personalize responses. Memory-Based Retrieval may also enhance experiences by storing past interactions. In some examples, Memory-Based Retrieval supports ongoing dialogues without re-establishing context. However, as storage grows, retrieval may become inefficient. Furthermore, there may be numerous privacy and compliance concerns associated with storing data. And, because past information may become outdated or irrelevant, reliance on past interactions may not provide the most relevant context.

Another approach is Graph-Based Context Retrieval, also a type of RAG approach, which may utilize graph data structures to organize and retrieve contextual information. In such systems, nodes within the graphs may represent entities or concepts, while edges may represent relationships. Such structures may enable complex context mapping and capture interdependencies between concepts, providing multi-faceted context beyond keyword matching. However, building and maintaining such graph structures may be resource-intensive, and large graphs may be computationally expensive to traverse. Additionally, Graph-Based Context Retrieval faces challenges in adapting graph structures to new information in real-time without significant restructuring. In contrast, Cognitive Graphs support real-time dynamic updates without restructuring, enabling continuous evolution of relationships and weights through interaction.

Another approach is Static Context Augmentation, which may involve appending a fixed set of background information to input regardless of the specific query. Static Context Augmentation may be easy to implement without complex retrieval mechanisms and may provide a stable foundation of information. However, Static Context Augmentation may not address the unique needs of each query. For example, insufficient context may result in generic or inaccurate answers. Conversely, excessive static context can overwhelm the system. For example, overloading a system with excessive or tangential information may lead to uncertainty and reduce response quality. And because static context is static, the appended information may not reflect the latest data or evolving contexts. In order to achieve a balance, sophisticated mechanisms may be required to filter and prioritize information based on the pertinence to the query. This may involve determining an intent and extracting the most salient pieces of information from vast datasets. The complexity of natural language and the diversity of possible interpretations may make this a non-trivial task.

While each of the above-described methods may have some benefits, they all struggle with adapting context in real-time to highly specific or unforeseen queries, and achieving high precision (relevance) without hallucinations and without sacrificing recall (completeness). Additionally, these methods are resource intensive, often requiring significant computational resources that affect scalability and cost-effectiveness. And combining multiple data sources and retrieval methods may lead to architectural complexity and maintenance difficulties. These limitations highlight the need for a next-generation contextual retrieval method that can overcome these obstacles by providing dynamic, precise, and efficient context generation tailored to individual inputs and adaptable to evolving information landscapes.

### Scalability Challenges

With respect to scalability, Graph-Based Retrieval systems may suffer from performance issues when scaling due to graph size and complexity, Memory-Based Retrieval system scalability may be limited by the size of the stored memory and the efficiency of retrieval mechanisms, and RAG Systems may experience latency due to the retrieval process, particularly with large datasets. As the volume of available data grows exponentially, effective contextual retrieval systems should be able to handle large-scale data efficiently without compromising speed or accuracy. This may include processing vast amounts of text, images, or structured data in real-time. The scalability challenges may be compounded when a system serves multiple users or processes simultaneously, each with unique context requirements. Ensuring consistent performance under heavy loads may require optimized algorithms and robust infrastructure capable of distributed processing and parallel computation. To handle growing knowledge bases efficiently, the methods, systems, and apparatuses disclosed herein may employ smart graph traversal algorithms utilizing weighted paths, context-aware loading that may prioritize relevant information, and/or distributed processing for improved performance. The methods, systems, and apparatuses disclosed herein may use weighted relationships, which may allow smart graph traversal algorithms to prioritize relevant paths, reducing computational overhead. In some examples, the methods, systems, and apparatuses disclosed herein may support distributed deployment, which may enhance performance under heavy loads. In some examples, the methods, systems, and apparatuses disclosed herein may load and process the most relevant parts of the graph based on the current context, which may optimize resource utilization.

### Hallucination Reduction

Traditional large language models and other systems relying solely on internal knowledge without external grounding may increase the risk of hallucinations—where a model or system may generate information that may appear plausible but may actually be incorrect, fabricated, or otherwise misleading. Hallucinations may be particularly problematic when a model or system lacks sufficient or accurate context. Without reliable grounding, a model or system may fill gaps with incorrect assumptions or misinformation. This may undermine the trustworthiness of a system and can have serious implications in applications where accuracy is critical (e.g., healthcare or legal industry). Other retrieval systems may not have robust mechanisms for assessing the confidence or reliability of retrieved information. The methods, systems, and apparatuses described herein may minimize hallucinations and improve response accuracy by detecting and managing conflicting information-which may prompt clarifications and/or prioritization of higher-confidence data, maintaining weighted relationships between concepts-which may allow the methods, systems, and apparatuses described herein to assess the reliability of information before including it in responses, tracking confidence scores for each connection, and/or grounding responses in a verifiable knowledge structure or cognitive graph.

### Data Integration and Governance Challenges

To maintain reliability across regenerated contexts, integrating diverse data sources may pose additional challenges. Amalgamating information from structured databases, unstructured text documents, APIs, and real-time data streams may each require different processing techniques and may present unique issues related to compatibility, consistency, and quality. In some examples, a flexible architecture may be required to handle heterogeneous data formats and ensure seamless access and retrieval. Additionally, certain data governance concerns, such as privacy, security, and regulations like the General Data Protection Regulation (GDPR) may require compliance.

### Context Evolution Over Time

One additional problem with the introduction of context is that the context itself may not be static (e.g., it may evolve over time). User preferences may change, new information may become available, and changing external factors may influence relevance. Because context may not be static, context may need to be reevaluated over time to determine its significance. Static context augmentation systems may not be able to adapt to new information or changing contexts, which may lead to outdated or irrelevant responses. While RAG and Memory-Based Retrieval systems may be able to incorporate new information, such systems may lack mechanisms for systematically weakening obsolete information. The present disclosure sets forth mechanisms for continuous learning with the ability to discard obsolete or less relevant data. For example, the methods, systems, and apparatuses disclosed herein continuously evolve to stay relevant through real-time weight adjustments based on interactions, natural decay of unused relationships over time, and/or dynamic integration of new contextual information. In some examples, the methods, systems, and apparatuses comprise a cognitive graph that evolves in real-time, incorporating new information and adjusting existing relationships as new data becomes available. In some examples, the knowledge base may expand organically through use, without requiring extensive manual updates or reconfigurations. In some examples, weight decay algorithms may be utilized to reduce the influence of outdated or less relevant relationships over time.

When it comes to real-time context adaptation, static systems may not be able to adjust to new information until manually updated. And updating context in batches may result in delays that may reduce real-time effectiveness. The methods, systems, and apparatuses disclosed herein excel in adapting to new information and changing contexts in real-time, which may result in up-to-the-moment accuracy. For example, the methods, systems, and apparatuses disclosed herein may incorporate new inputs and adjust the cognitive graph without significant delays. As context evolves, the methods, systems, and apparatuses disclosed herein ensure that responses remain accurate and relevant by continually updating the underlying knowledge representation. Furthermore, the methods, systems, and apparatuses disclosed herein account for temporal factors, recognizing the significance of recent information over older data.

### Introduction to Dynamic Cognitive Context System

As used herein, the term Cognitive Graph refers to a data structure that combines graph-based knowledge representation with vector-based semantic embeddings. Each node or edge in the graph may include one or more vector representations that encode contextual or semantic information, allowing both symbolic relationships and similarity-based reasoning to be performed within a unified framework. A Cognitive Graph therefore differs from a conventional knowledge graph in that the relationships between entities may be dynamically updated according to semantic proximity, usage history, and contextual weighting derived from, for example, interactions or learned embeddings.

To this end, the present disclosure sets forth systems, apparatuses, and methods that uniquely combine vector-based semantic processing with graph-based knowledge representation, leveraging the strengths of both approaches. The methods, systems, and apparatuses disclosed herein provide precise similarity searches and real-time context matching using vector embeddings to capture nuanced semantic relationships between concepts, while avoiding the hallucination risk inherent in systems lacking external grounding. The methods, systems, and apparatuses disclosed herein further support complex queries and improved reasoning through the structured, interpretable representation of knowledge provided by Cognitive Graphs, enabling dynamic relationship updates without the computational expense and restructuring burden imposed by traditional graph systems. In sum, the Cognitive Graph enables context regeneration that is both semantically precise and computationally efficient.

Entity storage systems may provide semantic similarity, but may lack the ability to represent complex relationships and may not capture hierarchical or relational information effectively. And while graph databases may be powerful for representing relationships, they may not handle semantic similarity and natural language understanding as effectively as vector-based systems. Node-based execution engines may provide deterministic routing, but such systems may be limited in horizontal scaling. Accordingly, the methods, systems, and apparatuses disclosed herein may include an integration layer that enables bidirectional transformation between non-deterministic language processing operations and deterministic graph storage operations. The integration layer may translate vector-based semantic operations (non-deterministic domain) into graph structure updates (deterministic domain), and conversely may translate graph retrievals (deterministic domain) into vector-based semantic representations (non-deterministic domain) suitable for inference engines. This bidirectional transformation may ensure coherence across components while enabling dynamic context regeneration through continuous transformation between non-deterministic (language processing) and deterministic (graph storage) domains. The bidirectional transformation may create feedback where retrieval operations modify structure and modified structure influences future retrievals, enabling the system to evolve its knowledge representation through usage, rather than requiring explicit programming of updates. The integration layer may be implemented as a distributed component across the entity processing system 402 and cognitive processing system 406, as a dedicated component within the execution processing system 410, or as a combination thereof, as described in greater detail below. By integrating an entity storage system with a Cognitive Graph, the activation of nodes within the cognitive graph may inherently modify the structure itself during retrieval operations, without requiring separate update instructions. This “memory as alteration” concept—where retrieval operations may automatically alter the cognitive structure it accesses—may enable generative evolution through usage patterns organically. Unlike traditional systems where retrieval and update are separate operations, the disclosed systems, methods, and apparatuses performs retrieval and structural modification together without requiring separate update instructions, which may allow cognitive pathways to continuously evolve based on experiences and interactions without explicit update commands.

In some examples, the methods, systems, and apparatuses disclosed herein may learn and evolve through several key mechanisms. First, when encountering a new term or relationship, the methods, systems, and apparatuses disclosed herein may initialize relationship weights to represent uncertainty between different possible meanings. In some examples, such initialization may comprise balanced weights (e.g., 0.5 when two interpretations exist, representing equal initial likelihood). This neutral starting point may allow the methods, systems, and apparatuses disclosed herein to naturally learn the correct interpretation through context and interactions. Second, as users or systems interact with the methods, systems, and apparatuses disclosed herein, the methods, systems, and apparatuses disclosed herein may create direct relationship nodes capturing intentions. For example, if a user expresses that he or she wants to buy a Viper, the methods, systems, and apparatuses disclosed herein may assign the explicit expression a high confidence score (1.0). The methods, systems, and apparatuses disclosed herein may also form connections/relationships between related concepts, like linking “Viper” to the broader category of “Car” or “Snake”.

In some examples, the methods, systems, and apparatuses disclosed herein may be able to handle words with multiple meanings by maintaining parallel relationship paths. When encountering ambiguous terms, the methods, systems, and apparatuses disclosed herein may analyze the weights of different interpretation paths to determine the most likely meaning. If multiple interpretations seem equally likely, the methods, systems, and apparatuses disclosed herein may provide multiple contextual interpretations for downstream systems to utilize, or may signal that disambiguation is needed.

In some examples, if users or systems clarify ambiguous meanings, the methods, systems, and apparatuses disclosed herein may update understanding accordingly. Confirmed interpretations may receive stronger weights (like increasing Viper->Car from 0.5 to 0.8), while alternative meanings become less likely (reducing Viper->Snake from 0.5 to 0.2).

Rather than discarding previous interactions, the methods, systems, and apparatuses disclosed herein may maintain a history of queries and clarifications in a graph structure. This accumulated knowledge may help the methods, systems, and apparatuses disclosed herein better understand context and resolve ambiguity in future interactions.

The methods, systems, and apparatuses disclosed herein provide a dynamic knowledge representation that may evolve through interaction. The methods, systems, and apparatuses disclosed herein may maintain semantic relationships and weights between meaning nodes, and may use weight-dampening algorithms to ensure relevance is preserved as the graph grows and changes over time. Unlike traditional graph databases that maintain strict separation between data structure and queries, the methods, systems, and apparatuses disclosed herein may continuously integrate new meaning nodes and relationship edges during normal operation, which may allow the knowledge representation to organically expand and refine itself through use.

The methods, systems, and apparatuses disclosed herein may advantageously perform nuanced contextual understanding and effective disambiguation. Unlike traditional retrieval systems that may return irrelevant or ambiguous results, the methods, systems, and apparatuses disclosed herein may leverage weighted relationships within the Cognitive Graph to maintain multiple interpretations of a concept and adjust them dynamically based on interactions. For example, the methods, systems, and apparatuses disclosed herein may represent multiple meanings of a word or concept simultaneously, each with associated confidence weights. This may allow the methods, systems, and apparatuses disclosed herein to handle ambiguity without discarding alternative interpretations prematurely.

Traditional systems may struggle with disambiguation due to reliance on static retrieval mechanisms and lack of dynamic context updating. While memory-based systems can utilize past interactions, they may not effectively adjust the relevance of different interpretations over time. Traditional graph-based systems may not dynamically adjust relationship weights or the structure of the graph based on real-time interactions, limiting their ability to refine context understanding. In contrast, the methods, systems, and apparatuses disclosed herein may adjust the weights of relationships through interactions and feedback, strengthening confirmed associations and weakening less relevant ones. This process may enhance the system's ability to disambiguate concepts over time. By analyzing the entire context of the interaction, including history and prior queries, the methods, systems, and apparatuses disclosed herein may provide more accurate and relevant responses.

In some examples, because the methods, systems, and apparatuses disclosed herein continuously update the weighting of various relationships over time based on all interactions, a first implementation of the methods, systems, and apparatuses disclosed herein in one location with one set of users or systems may differ significantly from a second implementation of the methods, systems, and apparatuses disclosed herein in another location and/or with another set of users or systems. The methods, systems, and apparatuses disclosed herein may create nodes and relationships specific to individual users or systems, which may involve preferences, history, and behavior. The methods, systems, and apparatuses disclosed herein may maintain persistent context, such that the methods, systems, and apparatuses disclosed herein may preserve continuity across interactions without re-establishing context each time. Additionally, the methods, systems, and apparatuses disclosed herein may be configured to respect privacy requirements, managing data responsibly.

Traditional systems may retrieve broadly relevant documents but lack fine-grained specificity. Static context augmentation may provide general information without tailoring to the specific query. In contrast, the methods, systems, and apparatuses disclosed herein may prioritize information based on the strength of relationships to enhance relevance. In some examples, the methods, systems, and apparatuses disclosed herein may filter out less relevant data, focusing on the most pertinent information for the query. In some examples, the methods, systems, and apparatuses disclosed herein may implement advanced algorithms to assess the quality and specificity of potential context elements before inclusion.

Additionally, other systems lack robust mechanisms for conflict resolution and context quality management, leading to inaccuracies or inconsistencies. In contrast, the methods, systems, and apparatuses disclosed herein may implement sophisticated mechanisms for managing context quality and resolving conflicts, contributing to more accurate and reliable outputs. For example, the methods, systems, and apparatuses disclosed herein may identify conflicting information within the graph and take appropriate action. And the methods, systems, and apparatuses disclosed herein may validate contextual inputs and assign quality scores, ensuring that only high-quality information influences the graph. In some examples, the methods, systems, and apparatuses disclosed herein may prune or otherwise decay obsolete or less relevant context systematically, keeping the graph focused and efficient.

### Dynamic Cognitive Context System Architecture

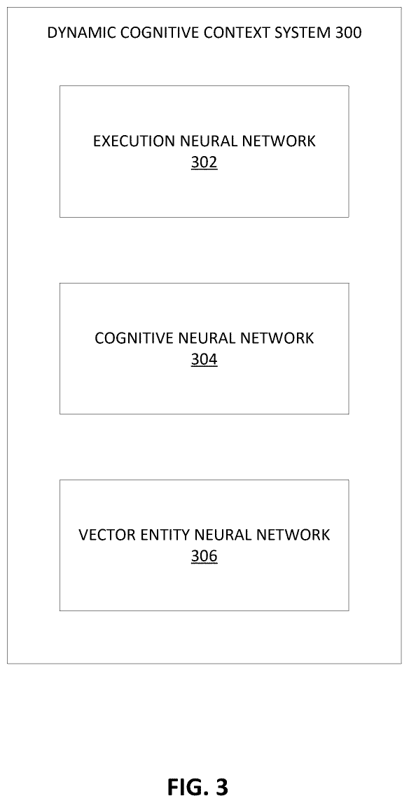

In sum, the methods, systems, and apparatuses disclosed herein may offer a holistic solution that overcomes the limitations of existing contextual retrieval methods. FIG. 3 illustrates an example dynamic cognitive context system 300 to improve contextualization in artificial intelligence applications, inference engines, retrieval systems, search engines, recommendation systems, knowledge management systems, and other computational systems requiring dynamic context generation.

The dynamic cognitive context system 300 may be designed to be highly flexible and adaptable, supporting a wide range of use cases and integration scenarios. In some examples, the dynamic cognitive context system 300 may provide contextual information to large language models, small language models, chatbots, virtual assistants, retrieval-augmented generation systems, search engines, recommendation systems, knowledge management systems, document processing systems, data analysis systems, or any other system that may benefit from dynamic context generation. In some examples, the dynamic cognitive context system 300 may be utilized by neural network-based systems, rule-based systems, hybrid systems, or any computational system requiring contextual information. In some examples, the dynamic cognitive context system 300 may utilize probability distributions to represent the relative likelihood of different interpretations or meanings, where weights assigned to alternative semantic mappings may sum to unity or may be normalized to represent comparative probabilities across possible contextual understandings.

In some examples, the dynamic cognitive context system 300 may operate in multiple architecture modes. In a per-user mode, the system may maintain separate Cognitive Graphs for individual users or systems, enabling personalized context without cross-contamination. In a shared mode, the system may maintain a single Cognitive Graph updated by all interactions, enabling collective learning. In a hybrid mode, the system may maintain both shared and user-specific graph components, allowing personalization while benefiting from collective knowledge. The architecture mode may be selected based on deployment requirements, privacy constraints, or application needs.

In some examples, the methods, systems, and apparatuses disclosed herein may capture and utilize user-specific or system-specific context for personalization. When operating in per-user or hybrid mode, the methods, systems, and apparatuses disclosed herein may create nodes and relationships specific to individual users or systems, which may involve preferences, history, and behavior. When operating in shared mode, nodes and relationships are shared across all users while maintaining user-specific interaction history where appropriate.

### Three-Network Architecture

As shown in FIG. 3, the dynamic cognitive context system 300 may include one or more neural networks. In some examples, the dynamic cognitive context system 300 may comprise an execution neural network 302, a cognitive neural network 304, and a vector entity neural network 306. Each of the execution neural network 302, the cognitive neural network 304, and the vector entity neural network 306 may comprise a number of interconnected neurons. In some examples, one or more neurons of one of the execution neural network 302, the cognitive neural network 304, or the vector entity neural network 306 may be interconnected with one or more neurons of another one of the execution neural network 302, the cognitive neural network 304, or the vector entity neural network 306. In some examples, a neuron may comprise a schema or predetermined behavior such that when non-deterministic input data or signals are received, the neuron may process and/or transform the data or signals deterministically. In some examples, non-deterministic data may comprise data exhibiting context-dependent variability when identical inputs may produce different interpretations based on current system state, recent interaction history, or environmental factors. In some examples, these schemas or predetermined behaviors may be analogous to DNA and may dictate how the neuron is to react to specific signal signatures, how to process information, and how to format processed information. In some examples, a neuron may comprise different schemas or predetermined behaviors (e.g., one neuron may have a linguistic schema while another neuron may have a mathematical schema). For example, a neuron may have a schema to convert natural language input into structured meanings (e.g., “entities”) for interaction with other neural networks (e.g., the cognitive neural network 304). In some examples, a neuron's schema may enable the normalization of noisy external information into storable formats from which relationships may be produced.

The execution neural network 302 may be optimized for heavy execution throughput, with execution neurons that may interpret signals, aggregate cognitive pathways, and generate prompts. The execution neural network 302 may be a node-based runtime optimized for vertical (e.g., processing power) scalability. This separation enables the system to scale execution capacity independently from contextual complexity, allowing computationally intensive operations to leverage specialized hardware while maintaining lightweight, horizontally-scalable cognitive pathways. For example, the neurons of the execution neural network 302 may be able to scale exponentially in processing power to execute large amounts of information. In some examples, the execution of large amounts of information may require significant resources and may limit the scalability (in terms of numbers of neurons) of the execution neural network 302. In some examples, the execution neural network 302 may comprise tens of thousands of neurons. A neuron of the execution neural network 302 may be configured to receive input (e.g., data, queries, signals, etc.) via one or more connections. Likewise, a neuron of the execution neural network 302 may be configured to transmit output (e.g., data, queries, signals, etc.) via one or more connections. In some examples, the execution neural network 302 neurons may comprise input signatures that may be compared to the received input. In some examples, the execution neural network 302 neurons may be configured to interpret non-deterministic inputs and transform the same into structured queries. In some examples, the execution neural network 302 neurons may be configured to combine outputs from one or more interconnected cognitive neural network 304 neurons. In some examples, the execution neural network 302 neurons may be configured to generate prompts for inference engines.

The cognitive neural network 304 may be optimized for contextual complexity, with cognitive neurons connected by multidimensional weighted edges. The cognitive neural network 304 may be a graph-based runtime optimized for horizontal (e.g., number of neurons) scalability. For example, the neurons of the cognitive neural network 304 may be able to scale in terms of the number of neurons and/or the connections therebetween to provide deep contextual association. In some examples, the deep contextual association may not require substantial processing power (e.g., may merely be a snapshot of the neural network nodes/connections), such that the cognitive neural network 304 may scale up to millions of neurons. A neuron of the cognitive neural network 304 may comprise one or more connections with other neurons (either other cognitive neural network 304 neurons or execution neural network 302 neurons). In some examples, a neuron of the cognitive neural network 304 may comprise multidimensional weights. The multidimensional weights may represent contextual dimensions such as rational, emotional, and temporal dimensions. In some examples, the neurons of the cognitive neural network 304 may be associated with metadata signatures, which may define a contextual role.

The vector entity network 306 may be optimized for semantic anchoring. A neuron of the vector entity network 306 may be positioned in a high-dimensional vector space. In some examples, the neurons may be positioned according to semantic similarities. In some examples, the neurons of the vector entity network 306 may represent deterministic entities distilled from non-deterministic input signals. In some such examples, the deterministic entities may be fixed references that stabilize a cognitive graph, thereby enabling reliable regeneration of context.

In operation, the execution neural network 302, the cognitive neural network 304, and the vector entity neural network 306 may be a unified neural runtime. In some examples, one or more neurons of the execution neural network 302 may request contextual pathways from the cognitive neural network 304. In some examples, one or more neurons of the cognitive neural network 304 may refine pathways by referencing deterministic entities in the vector entity neural network 306. In some examples, one or more neurons of the vector entity neural network 306 may be continuously updated upon receipt of non-deterministic signals, which may include distilling additional stabilized entities into the cognitive graph.

Illustrative Example: Learning from Environmental Interactions

In an example implementation of the three-network architecture, image data (e.g., photos and/or live/recorded video) and audio data relating to a child being severely burned by a flame from a stovetop may be received. The cognitive neural network 304 may develop a relationship between a node associated with fire and a node associated with injury. In some such examples, audio data relating to someone calling emergency services (e.g., an ambulance) may be subsequently received. In a similar manner, the cognitive neural network 304 may develop a relationship between the node associated with injury and a node associated with calling emergency services. These specific circumstances may enable the dynamic cognitive context system 300 to, in response to receipt of subsequent sensory information indicating a house fire, identify the potential dangerous circumstances associated with a house fire and, based on prior knowledge associating fire with the fire department (e.g., based on a prior association created by the cognitive neural network 304, based on internet data, based on pre-trained information) and based on location information, determine to alert the proper emergency service (e.g., the local fire department) to resolve the detected house fire. In a similar manner, the cognitive neural network 304 may determine that the house fire may cause injury, and recommend navigation to a safe location (e.g., outside of the house). Any implemented actions (e.g., calling the local fire department and navigating to a safe location) may enable the cognitive neural network 304 to create even further relationships based on whether the determined actions taken were successful, unsuccessful, and to what degree. As such, the dynamic cognitive context system 300 may continuously adapt and improve based on its interactions with the environment.

### Implementation Via Processors and Storage Systems

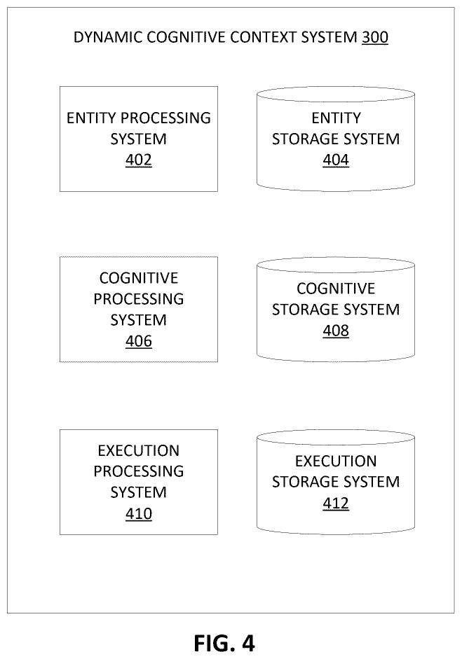

As shown in FIG. 4, the dynamic cognitive context system 300 may implement the execution neural network 302, the cognitive neural network 304, and the vector entity network 306 via a number of cooperative processors and storage systems. The dynamic cognitive context system 300 may comprise an entity processing system 402, an entity storage system 404, a cognitive processing system 406, a cognitive storage system 408, an execution processing system 410, and an execution storage system 412 that work together to provide dynamic context generation.

The entity processing system 402 may handle semantic understanding and transformation. The entity storage system 404 may manage vector-based knowledge storage. The cognitive processing system 406 may orchestrate graph operations and context translation. The cognitive storage system 408 may provide the core knowledge representation layer through the Cognitive Graph storage structure. The execution processing system 410 may process execution operations. The execution storage system 412 may store execution-related data.

In some examples, an integration layer may facilitate bidirectional translation between vector operations and graph updates, ensuring coherence across the entity processing system 402 and the cognitive processing system 406. The bidirectional transformation may translate non-deterministic vector operations into deterministic graph structure modifications, and translate deterministic graph retrievals into non-deterministic semantic representations for inference engines. This bidirectional transformation may create feedback where retrieval operations modify structure, and modified structure influences future retrievals, enabling continuous evolution without explicit update instructions.

Together, the entity processing system 402, the entity storage system 404, the cognitive processing system 406, the cognitive storage system 408, the execution processing system 410, and the execution storage system 412 may provide dynamic context regeneration. In some such examples, the entity processing system 402, the entity storage system 404, the cognitive processing system 406, the cognitive storage system 408, the execution processing system 410, and the execution storage system 412 may enable accurate and scalable cognitive operations for inference engines and related systems. In operation, the entity processing system 402, the entity storage system 404, the cognitive processing system 406, the cognitive storage system 408, the execution processing system 410, and the execution storage system 412 may form a unified system that, based on complementary properties of the entity processing system 402, the entity storage system 404, the cognitive processing system 406, the cognitive storage system 408, the execution processing system 410, and the execution storage system 412, enables dynamic regeneration of context for inference engines and artificial intelligence systems that improves scalability, stability, and accuracy when compared to RAG, graph, and/or memory based systems.

In some examples, the entity processing system 402 may request or receive data from one or more sources. In some examples, the entity processing system 402 may work in conjunction with the entity storage system 404 to identify existing information entities and/or extract or generate new information entities. The entity processing system 402 may forward entity information to the cognitive processing system 406. In some examples, the cognitive processing system 406 may generate or update semantic mappings based on the entity information. The cognitive processing system 406 may work in conjunction with the cognitive storage system 408 to store and retrieve semantic mappings, nodes, relationships, and weights. In some examples, the cognitive processing system 406 may refine contextual pathways by referencing deterministic entities in the entity storage system 404. In some examples, the entity storage system 404 may be continuously updated upon receipt of data or signals, which may include distilling additional stabilized entities into the cognitive graph. In some examples, retrieval operations performed by the cognitive processing system 406 may inherently alter the cognitive structure stored in the cognitive storage system 408 during the retrieval process itself, without requiring separate update operations. This automatic structural modification during retrieval may enable the cognitive graph to evolve organically through usage. In some examples, the execution processing system 410 may implement the execution neural network 302 as a node-based topology optimized for vertical scalability, where individual execution nodes can scale in processing power to handle computationally intensive operations. In some examples, execution nodes may interpret signals based on embedded schemas, aggregate cognitive pathways from the cognitive neural network 304, generate prompts for inference engines, and selectively route outputs based on signal characteristics and node logic. The execution storage system 412 may store the schemas, routing configurations, and execution state information that define the behavior and interconnections of execution nodes.

### Entity Processing System

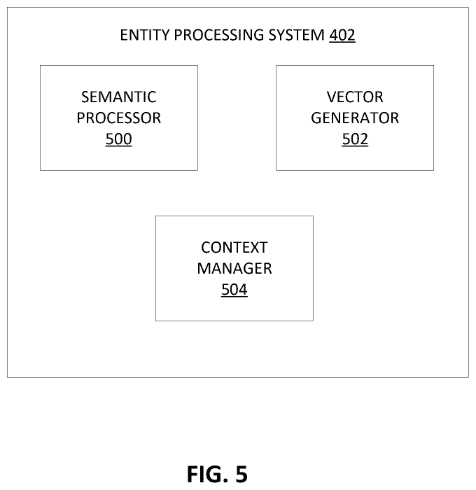

FIG. 5 illustrates an example implementation of the entity processing system 402. The entity processing system 402 may serve as the semantic understanding and transformation layer of the dynamic cognitive context system 300. The entity processing system 402 may convert natural language and other inputs into structured vector representations that can be processed by the dynamic cognitive context system 300. In some examples, the entity processing system 402 may handle multimodal inputs including text, images, audio, or combinations thereof. In some examples, the multimodal inputs including text, images, audio, or combinations thereof may be processed and aligned into a unified semantic space, where cross-modal entities are represented with coherent semantic relationships managed by the entity processing system 402 and cognitive processing system 406

In the illustrated example of FIG. 5, the entity processing system 402 may comprise a semantic processor 500, a vector generator 502, and a context manager 504. The example semantic processor 500 may perform natural language processing operations including tokenization, normalization, and syntactic analysis to structure inputs for processing. For example, the semantic processor 500 may receive queries for use in systems requiring contextual information. The semantic processor 500, in connection with the entity storage system 404, may entitize such queries. The semantic processor 500 may process the queries and entities according to natural language processing techniques, breaking up the queries according to syntax such as subject (e.g., noun), intent (e.g., verb), object (e.g., direct/indirect noun), qualifier (e.g., adjective, adverb), and the like.

The semantic processor 500 may implement a semantic processing pipeline. In some examples, the semantic processing pipeline may perform input tokenization and normalization, semantic embedding generation, context enrichment and metadata attachment, and output vector preparation. In some examples, the semantic processor 500 may track temporal context, preserve domain context, manage user or system sessions, and capture environmental context.

The example vector generator 502 may generate vector embeddings from the structured outputs of the semantic processor 500 using embedding models. The example vector generator 502 may use one or more embedding models in its vector generation. For example, the example vector generator 502 may use models such as Bidirectional Encoder Representations from Transformers (BERT), Robustly optimized BERT Approach (RoBERTa), Word2Vec, FastText, or domain-specific models. In some examples, the vector generator 502 may perform interactive real-time streaming. In some examples, the vector generator 502 may perform batch processing for large datasets. In some examples, the vector generator 502 may take a hybrid approach and perform both real-time and large batch processing at different times and/or for different data. In some examples, the input data processed by the entity processing system 402 may comprise non-deterministic data, such as stochastic sensor readings, probabilistic model outputs, user queries with ambiguous intent, or data from sources exhibiting context-dependent variability where identical inputs may produce different interpretations based on current system state, recent interaction history, or environmental factors.

The vector generator 502 may perform various vector operations including similarity computation, dimensionality management, vector normalization, and distance metrics. Example distance metrics may include cosine similarity, Euclidean distance, or custom metrics for specific domains. In some examples, the vector generator 502 may implement search capabilities including exact k-NN (k nearest neighbors) for precise matching, approximate nearest neighbors (ANN), hybrid searching combining multiple approaches, multi-vector queries, filtered semantic search, context-aware ranking, and relevance scoring.

The example context manager 504 may forward its processed structured vector representations to the example cognitive processing system 406. In some examples, the context manager 504 may further track context over time, manage user or system sessions, capture additional context from an environment, and preserve domain context.

In some examples, the entity processing system 402 may comprise a graph integration layer. The graph integration layer may perform vector-to-graph translation, synchronization, and quality control. To perform vector-to-graph translation, the example entity processing system 402 may perform semantic similarity to graph weight conversion, infer relationship types and classifications, estimate and score confidence and uncertainty, propagate and enrich metadata, and optimize graph topology. The example entity processing system 402 may provide real-time updates for interactive sessions, synchronize batch or bulk operations, detect and resolve conflicts, control version and track history, and validate consistency. The example entity processing system 402 may assess vector quality and coherence, validate and verify embeddings, monitor and analyze performance, automatically detect errors and correct the same, and perform data integrity checks.

In some examples, the entity processing system 402 may perform system optimization, which may include resource management and performance tuning. In terms of resource management, the entity processing system 402 may perform dynamic memory allocation and utilization, intelligent computation scheduling, distributed load balancing, multi-level cache optimization, resource usage monitoring, and garbage collection tuning. In terms of performance tuning, the entity processing system 402 may perform adaptive embedding model selection, dynamic batch size optimization, parallel thread management, hardware acceleration configuration, pipeline optimization, and bottleneck identification.

### Entity Storage System

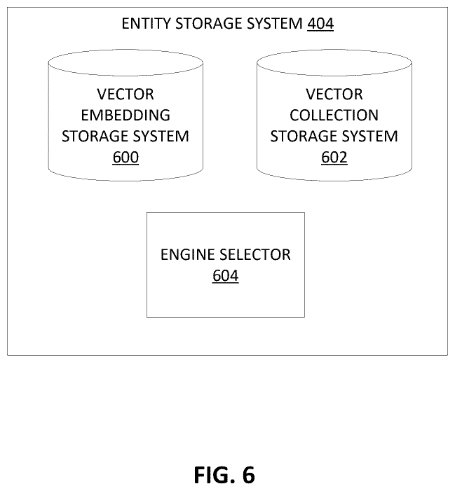

FIG. 6 illustrates an example implementation of the entity storage system 404. The entity storage system 404 may store and manage high-dimensional vector representations of concepts and entities. For example, the entity storage system 404 may store entities associated with words or phrases of one or more languages. The entity storage system 404 may store vector embeddings. The entity storage system 404 may be implemented in various ways. In some examples, the entity storage system 404 may be implemented in-memory for latency-sensitive operations. In some examples, the entity storage system 404 may be implemented with disk-drives (e.g., hard disk drives (HDD), solid state drives (SSD)) for large-scale persistence. In some examples, the entity storage system 404 may be implemented with a hybrid approach (e.g., in-memory and hard-disk) for balanced performance. In some examples, the entity storage system 404 may be implemented according to sharding strategies by domain, by access patterns, by update frequency, or any combination thereof.

In the illustrated example of FIG. 6, the entity storage system 404 may comprise a vector embedding storage system 600, a vector collection storage system 602, and an engine selector 604. In some examples, the vector embedding storage system 600 may store vector embeddings as dense vectors (e.g., with dimensionality 256-1024). In some examples, the vector embedding storage system 600 may store vector embeddings as sparse vectors (e.g., less than 255 dimensionality). In some examples, the stored vector embeddings may be multi-modal (e.g., text, image, and/or audio).

In some examples, the vector collection storage system 602 may organize the vector embeddings according to semantic groupings, hierarchical structures, cross-collection relationships, and namespace management. The vector collection storage system 602 may store metadata such as version history, temporal markers, confidence scores, domain annotations or specifications, data source(s), update frequency, and quality metrics associated with the vector embeddings.

The example engine selector 604 may select between Facebook AI Similarity Search (FAISS), Milvus, Pinecone, Weaviate, or other suitable engines. In some examples, the engine selector 604 may select FAISS for high-performance computing. In some examples, the engine selector 604 may select Milvus for distributed deployments. In some examples, the engine selector 604 may select Pinecone for managed services. In some examples, the engine selector 604 may select Weaviate for schema-based implementations.

The entity storage system 404 may comprise a searching infrastructure to find and retrieve vector representations and/or entities upon request from the entity processing system 402. In some examples, the entity storage system 404 may perform vector similarity searches based on the vector embeddings. In some examples, the searching infrastructure may comprise a number of algorithms including, for example, exact k-NN search, Hierarchical Navigable Small World (HNSW), Inverted File Index (IVF), and Product Quantization (PQ). In some examples, the entity storage system 404 may utilize such searching infrastructure to conduct multi-vector operations, vector and metadata (e.g., hybrid) searching, range-based queries, batch processing, filtered semantic searching and the like. In some examples, the similarity thresholds may be configurable.

The entity storage system 404 may perform a number of vector operations. For example, the entity storage system 404 may create, index, update, version, assess the quality of, and delete vector representations upon request from the entity processing system 402. Additionally, the entity storage system 404 may perform index optimizations, vector normalizations, dimensionality management, performance monitoring, and data integrity checks.

In some examples, the entity storage system 404 may integrate with Cognitive Graph systems. In order to integrate with such systems, the entity storage system 404 may perform vector-to-node mapping. In some examples (e.g., atomic concepts), the vector-to-node mapping may be one-to-one. In some examples (e.g., complex entities), the vector-to-node mapping may be one-to-many. In some examples (e.g., aggregated concepts), the vector-to-node mapping may be many-to-one. In some examples, the vector-to-node mapping may include bidirectional references.

The entity storage system 404 may further comprise a semantic bridge. The semantic bridge may perform vector similarity translation, metadata propagation, type inference, and bridge optimization. In some examples, the bridge optimization may comprise caching strategies, lazy loading, prefetching, and background processing. The entity storage system 404 may further monitor vector quality metrics, search performance tracking, integration status, system diagnostics, and resource utilization.

### Cognitive Processing System

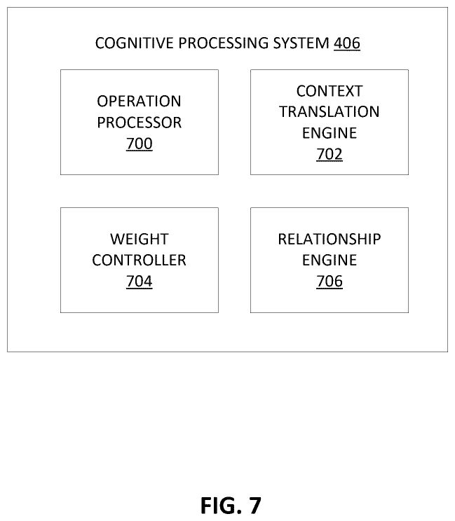

FIG. 7 illustrates an example implementation of the cognitive processing system 406. The cognitive processing system 406 may serve as a bridge between vector-based semantic understanding and Cognitive Graph-based knowledge representations. The example cognitive processing system 406 may transform contextual insights into concrete graph operations and maintain semantic coherence. In some examples, the cognitive processing system 406 may further transform the output of the cognitive storage system 408 into a form compatible with an inference engine based on the (updated) nodes/connections from the cognitive storage system 408 as well as the context of the input data. In some such examples, the cognitive processing system 406 may generate natural language context (in chatbot implementations), or imagery context (in image editing/generation implementations), for the inference engine.

In the illustrated example of FIG. 7, the cognitive processing system 406 may comprise an operation processor 700, a context translation engine 702, a weight controller 704, and a relationship engine 706. The example operation processor 700 may perform graph mutations by performing node operations, edge operations, property modifications, and graph traversals. Example node and edge operations may include creation, updating and deletion of nodes or edges. The example operation processor 700 may perform additional operations such as atomic operations, batch processing, transactional sequences, and rollback-capable mutations.

The example context translation engine 702 may perform semantic mapping and consistency management. In some examples the semantic mapping may comprise entity-to-node conversion, relationship inference, weight calculations, and context validation. In some examples, the consistency management may comprise context preservation, relationship coherence, temporal consistency, and domain constraints.

The example weight controller 704 may comprise a number of adjustment algorithms and weighting features. The example adjustment algorithms may include linear adjustments, exponential decay, sigmoid normalization, and Bayesian updating. The example weighting features may include multi-dimensional weights, temporal decay, confidence scoring, and domain-specific formulas. An example implementation for decay is shown below as Example 1:

Example 1
def adjust_weight(current_weight, time_elapsed):
decay_rate = 0.1 # Configurable
decay_factor = math.exp(−decay_rate * time_elapsed)
return current_weight * decay_factor

As shown in Example 1, assigned weights may decay over time to prevent weighting from becoming stale and impacting decisions that are based on such weighting. For example, a strongly weighted relationship between nodes that may have been formed over a year ago may not be as strong today, especially if no subsequent weighting adjustments have been made throughout the last year.

The example relationship engine 706 may manage types and optimize paths. Regarding type management, the example relationship engine 706 may infer relationships, ensure bidirectional consistency, and validate types. The example relationship engine 706 may also use weight-based routing, semantic validation, and path efficiency for path optimization.

In operation, the example cognitive processing system 406 may handle transactions, coordinate resources, and strategize processing. Regarding transaction handling, the example cognitive processing system 406 may ensure Atomicity, Consistency, Isolation, and Durability (ACID) compliance, eventual consistency, isolation levels, and conflict resolution. The example cognitive processing system 406 may schedule operations, balance loads, handle failure recovery, and monitor health in order to coordinate resources. Additionally, the example cognitive processing system 406 may adopt stream processing for real-time updates, perform batch processing for bulk operations, adopt a hybrid approach for processing mixed workloads, and manage priority queues.

The example cognitive processing system 406 may perform system validations on Cognitive Graphs including schema validation, semantic checks, relationship validation, and weight verification. The example cognitive processing system 406 may further perform maintenance operations such as graph cleanup, weight rebalancing, orphan detection, and integrity checks.

Like the example entity processing system 402, the example cognitive processing system 406 may integrate with vector systems. In some examples, the cognitive processing system 406 may integrate with the entity processing system 402. In some such examples, the cognitive processing system 406 may comprise a vector integration layer. The vector integration layer may perform similarity score conversions, threshold management, context mapping, and cache handling. The example cognitive processing system 406 may provide real-time updates, synchronize batch or bulk operations, handle priority, and distribute loads.

### Cognitive Storage System

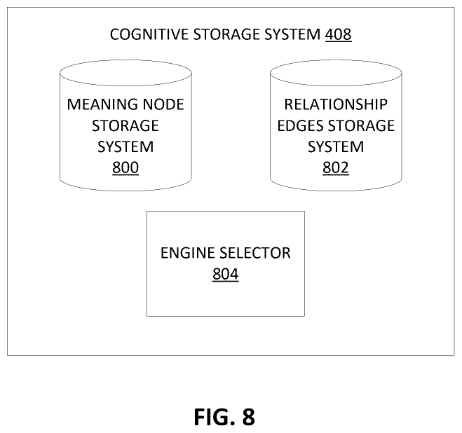

FIG. 8 illustrates an example implementation of the cognitive storage system 408. The cognitive storage system 408 may act as the core storage and retrieval component of the dynamic cognitive context system 300. The cognitive storage system 408 may store and manage the relationships of high-dimensional vector representations of concepts and entities that form the Cognitive Graph structure. The cognitive storage system 408 may be built on meaning nodes and relationship edges that evolve through interaction. In some examples, the cognitive storage system 408 may be implemented according to a number of storage approaches. For example, relating to sparse graphs, the cognitive storage system 408 may implement adjacency lists. For examples relating to dense graphs, the cognitive storage system 408 may implement adjacency matrices. In some examples a hybrid solution combining both adjacency lists and adjacency matrices may be beneficial. In some examples, the cognitive storage system 408 may scale horizontally, vertically, according to sharding strategies, or according to replication policies.

In the illustrated example of FIG. 8, the cognitive storage system 408 may comprise a meaning node storage system 800, a relationship edges storage system 802, and an engine selector 804. The example meaning node storage system 800 may store meaning nodes that form the Cognitive Graph. In some examples, the meaning nodes may store natural language text. In some examples, the meaning nodes may store annotations (e.g., “is the capital of Germany”), classifications (e.g., entity, concept, city, country), structured attributes (e.g., population, area), metadata (e.g., creation time, confidence), and the like.

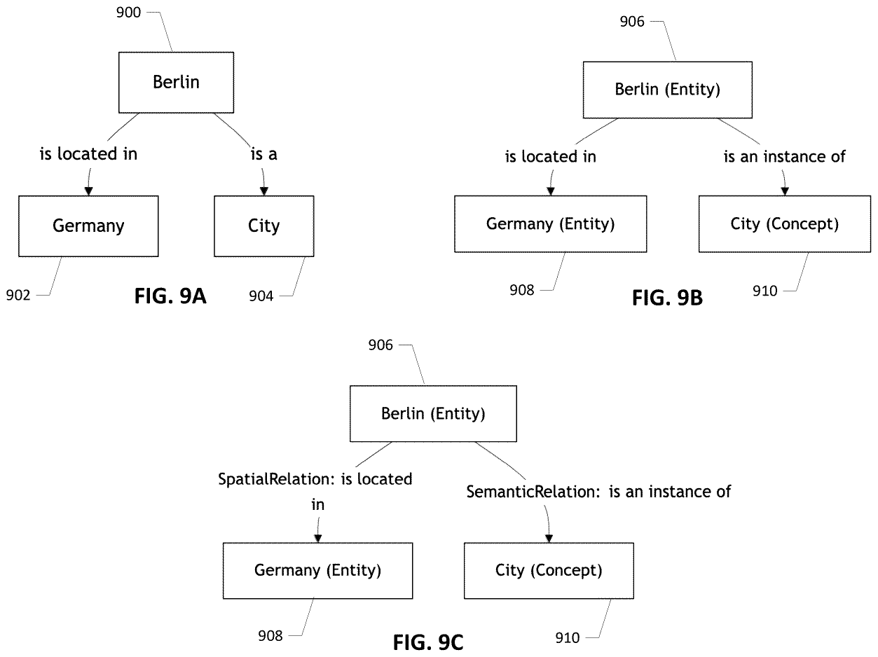

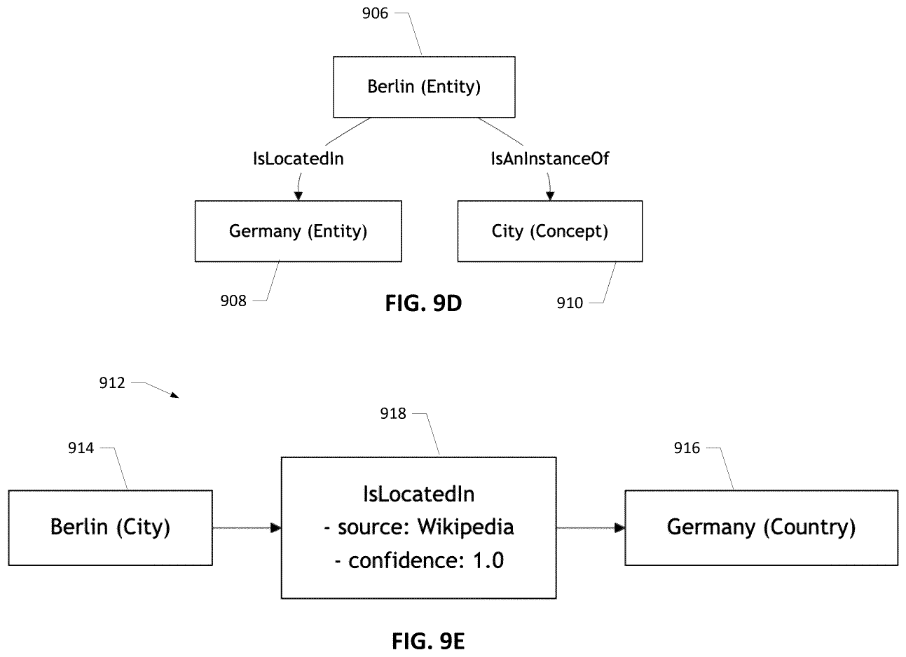

In some examples, the relationship edges storage system 802 may store the semantic connections or relationships between nodes, as further illustrated and described below with reference to FIGS. 9A-9E. In some examples, the semantic connections may be weighted, by the cognitive processing system 406, at values between zero and one according to the strength of the connections between nodes. In some examples, the weighting may be multi-dimensional, context-specific, distributed according to probability, customized according to schemes like fuzzy logic, neural networks, or any combination thereof. In some examples, the semantic connections may be spatially related (e.g., within a threshold distance), semantically related (e.g., related to a threshold degree), temporally related (e.g., temporarily, for a threshold amount of time, for at least a threshold amount of time), or related based on a custom domain.

The example engine selector 804 may select between Neo4j, Amazon Neptune, JanusGraph, ArangoDB, or other suitable engines. In some examples, the engine selector 804 may select Neo4j for production-grade storage and retrieval. In some examples, the engine selector 804 may select Amazon Neptune for cloud-native storage and retrieval. In some examples, the engine selector 804 may select JanusGraph for distributed storage and retrieval. In some examples, the engine selector 804 may select ArangoDB for multi-model storage and retrieval.

The cognitive storage system 408 may accept queries in a number of languages. For native graph implementations, the cognitive storage system 408 may accept Cypher queries. For cross-platform implementations, the cognitive storage system 408 may accept Gremlin queries. For modern API implementations, the cognitive storage system 408 may accept GraphQL queries. For domain-specific implementations, the cognitive storage system 408 may accept custom DSL queries. The cognitive storage system 408 may be able to implement path traversal and pattern matching, weight-based filtering, temporal queries, aggregations, and custom algorithms.

The cognitive storage system 408 may be able to be dynamically updated in real time. For example, the cognitive processing system 406 may create nodes, with the cognitive storage system 408 persistently storing the created nodes. The cognitive processing system 406 may delete or modify nodes stored in the cognitive storage system 408. In a similar manner, the cognitive processing system 406 may update relationship or connection strengths, with the cognitive storage system 408 persisting these updates in real time. Over time, the cognitive processing system 406 may evolve the context associated with nodes and their connections/relationships, with the cognitive storage system 408 persistently storing the evolved contextual state. In some examples, the cognitive storage system 408 may persistently store histories associated with users or systems (e.g., prior queries, prior responses to such queries).

The cognitive processing system 406 may further manage the weights of the various nodes/connections/relationships. As described herein, the cognitive storage system 408 may store the weights of the various nodes/connections/relationships. In some examples, the weights may be dynamically updated. In some examples, the cognitive processing system 406 may calculate weight updates, storing them in the cognitive storage system 408. In some examples, the cognitive processing system 406 may update weights according to one or more decay algorithms. In some examples, the cognitive processing system 406 may implement reinforcement mechanisms (e.g., where weighting of nodes/connections/relationships amongst various interactions may be similar), updating relationship weights stored in the cognitive storage system 408. In some examples, the cognitive processing system 406 may perform conflict resolution (e.g., where weighting of nodes/connections/relationships amongst various interactions may be different) when contradictory relationships are detected in the cognitive storage system 408.

The cognitive storage system 408 may implement a number of operational features associated with storage systems. For example, the cognitive storage system 408 may manage transactions, optimize performance, and conduct maintenance. In some examples, the cognitive storage system 408 may ensure ACID compliance, maintain consistency levels, perform isolation guarantees, and implement recovery mechanisms. In some examples, the cognitive storage system 408 may implement any number of caching strategies, perform index management, optimize queries, and allocate resources. In some examples, the cognitive storage system 408 may perform health monitoring, backup procedures, data integrity checks, and graph cleanup.

The cognitive storage system 408 may further perform vector-to-graph integration support. For example, the cognitive storage system 408 may act as a bridge to the entity storage system 404. In some examples, the cognitive storage system 408 may perform event streaming, batch processing, and manage API endpoints. In some examples, the cognitive storage system 408 may format data imported or exported, support versioning of nodes/connections/relationships, evolve schemas, and provide migration tools.

### Execution Processing System

The execution processing system 410 may implement a network topology comprising execution nodes, each execution node comprising an embedded schema or predetermined behavioral pattern (analogous to genetic instructions or “DNA”) that outlines how the node processes input signals and generates output signals. In some examples, the embedded schema may dictate how a node interprets specific signal signatures, transforms information, and formats processed information for downstream consumption. The execution nodes may delegate actual execution operations to a runtime layer, which may comprise one or more inference engines, Application Programming Interfaces (APIs), deterministic computational functions, or combinations thereof.

### Execution Storage System

The execution storage system 412 may store execution-related data including node schemas, execution states, signal routing information, and delegation configurations. Together, the execution processing system 410 and execution storage system 412 may enable the dynamic cognitive context system 300 to interpret non-deterministic input signals, transform them into structured representations, aggregate outputs from the cognitive processing system 406, generate contextually accurate prompts for inference engines, and route processed information to subsequent processing stages.

### Knowledge Operations

The entity processing system 402 may perform a knowledge ingestion process to transform raw unstructured text into structured knowledge. For example, upon receipt of data (such as documents, images, etc.), the entity processing system 402 may chunk the data into manageable segments. From the segments, the entity processing system 402 may, in conjunction with the entity storage system 404, identify existing information entities and/or extract or generate new information entities. In some examples, information entities may be formalized definitions of information, transformed from natural language into a structured format that represents relationships. In some examples, each entity may be associated with an entity name, a category or type, a description, an indication of whether the entity is overarching, an indication of whether the entity is structural, and/or an indication of whether the entity is from thought generation. In some examples, information entities may represent knowledge within a graph. Based on the entities, the system may be able to understand and process key aspects of information by transforming them into specific, recognizable entities. In some examples, an information entity may normalize potentially unreliable or noisy external information into a stable, storable format from which clear relationships can be derived and utilized within the system. For example, “dog,” may be an entity structured according to relationships with “domesticated,” “animal,” “four-legged,” and “bark.” Other examples may include “car,” “building,” or “fire.”

Extracted or generated new entities may be stored in the entity storage system 404. In some examples, the entity processing system 402 may prompt an inference engine (e.g., LLM) based on objectives to generate entities or entity types from data segments. The entity processing system 402 may format structural entities from the entity types received from the inference engine. In some examples, the entity processing system 402 may compare extracted entities to existing entities within the entity storage system 404. The entity processing system 402 may extract entities directly from input data using semantic analysis techniques, or may prompt an inference engine to extract entities from data segments, which the entity processing system 402 may then parse and process. In some such examples, the entity processing system 402 may use vector similarity to detect duplicative entities based on the comparison. In some examples, a duplicate may be detected if the vector similarity exceeds a similarity threshold (e.g., greater than or equal to 85% similar). In some examples, the entity processing system 402 may create relationships between entities. In some examples, the entity processing system 402 may search for related existing entities. In some such examples, the entity processing system 402 may create overarching entities based on related existing entities. In some examples, the entity processing system 402 may create source documents and links to entities. In some examples, a source may represent the source documents in the knowledge graph. In some such examples, sources may be associated with source text content and an indication of whether the source is from thought generation. In some examples, the entity processing system 402 may build comprehensive search context from multiple sources.

In some examples, the entity processing system 402 may perform knowledge retrieval. The entity processing system 402 may perform multi-modal searches by combining vector similarity for semantic understanding, graph relationships for contextual connections, structured and unstructured data processing, and source tracking for provenance and verification. In some examples, the entity processing system 402 may perform multiple search strategies (vector, graph, or a hybrid of the two). In some examples, the entity processing system 402 may use natural language processing and inference engine capabilities to identify key concepts. In some examples, the cognitive processing system 406 may explore entity relationships through multi-hop traversal. In some examples, the entity processing system 402 may support various filters for different search scenarios. In some examples, the entity processing system 402 may use sentence transformers for embeddings in order to implement a vector search.

In some examples, the dynamic cognitive context system 300 may perform knowledge generation. In some examples, the dynamic cognitive context system 300 may generate new thoughts based on existing knowledge. The dynamic cognitive context system 300 may use comprehensive context for thought generation. In some examples, the entity processing system 402 may extract new entities from generated thoughts. In some examples, new knowledge and thoughts may be stored in the entity storage system 404 and/or the cognitive storage system 408. In some examples, the entity processing system 402 may combine thought entities and non-thought entities in a dual searching strategy. Thought entities may represent knowledge derived from system-generated inferences or reasoning processes (e.g., inferred or generated entities created through cognitive processing), while non-thought entities may represent knowledge directly extracted from external data sources (e.g., deterministic entities extracted from input data). This dual approach may allow the system to leverage both explicitly provided information and internally generated insights. In some examples, the dynamic cognitive context system 300 may continuously generate thoughts and build knowledge. The dynamic cognitive context system 300 may implement feedback loops to iteratively improve and refine. In this regard, the dynamic cognitive context system 300 may continuously learn, improve, and expand knowledge over time.

In some examples, the dynamic cognitive context system 300 may perform entity management. For example, the dynamic cognitive context system 300 may filter entities by category, name, and/or exactness. The dynamic cognitive context system 300 may optimize storage system queries with indexing and build queries based on parameters. In some examples, the dynamic cognitive context system 300 may automatically find and attach primary sources. The dynamic cognitive context system 300 may perform detailed logging for debugging and monitoring.

### Meaning Nodes and Relationship Edges

As described above, the cognitive storage system 408 may store meaning nodes and relationship edges. These meaning nodes and relationship edges may form the basis of a Cognitive Graph. In some examples, untyped meaning nodes and untyped relationship edges may be the building blocks of the Cognitive Graph.

In some examples, untyped meaning nodes may represent raw concepts, entities, or facts. Untyped meaning nodes may contain unstructured natural language text without any formal schema, metadata, or typing. For example, the fact that “Berlin is a city in Germany” may be an untyped meaning node. As another example, an untyped meaning node may have unstructured characteristics. Example 2 illustrates the above fact (“Berlin is a city in Germany”) serving as a container for arbitrary characteristics set forth as natural language text:

Example 2
Berlin
- is a city
- is located in Germany

In some examples, untyped relationship edges may connect meaning nodes using natural language relationships. In this manner, unstructured characteristics may be converted into semantic relationships between meaning nodes, as shown in FIG. 9A. As illustrated in FIG. 9A, each portion of the above fact (“Berlin is a city in Germany”) may be represented by meaning nodes and connections or semantic relationships between the meaning nodes. The word “Berlin” may form a first untyped meaning node 900, the word “Germany” may form a second untyped meaning node 902, and the word “City” may form a third untyped meaning node 904. The first untyped meaning node 900 (“Berlin”) may be connected or otherwise semantically related to both the second untyped meaning node 902 (“Germany”) and the third untyped meaning node 904 (“City”). The relationship between the first untyped meaning node 900 (“Berlin”) and the second untyped meaning node 902 (“Germany”) may be represented with the “is located in” language. The relationship between the first untyped meaning node 900 (“Berlin”) and the third untyped meaning node 904 (“City”) may be represented with the “is a” language. While the example of FIG. 9A illustrates a simplistic Cognitive Graph, more complex Cognitive Graphs may be formed based on these described principles.

In some examples, cognitive storage system 408 may extend the Cognitive Graph with additional structure and semantic meaning to support more complex queries and relationships. In some examples, the cognitive processing system 406 may create (and the cognitive storage system 408 may store) typed meaning nodes and typed relationship edges to extend the Cognitive Graph with additional structure and semantic meaning. FIG. 9B illustrates a block diagram of the Cognitive Graph of FIG. 9A extended with typed meaning nodes. Typed meaning nodes may have separate classes assigned to them, which may categorize the nodes semantically and may enable the development of more structured schemas. As shown in FIG. 9B, the word “Berlin” may be assigned as an “Entity” to form a first typed meaning node 906, the word “Germany” may be assigned as an “Entity” to form a second typed meaning node 908, and the word “City” may be assigned as a “Concept” to form a third typed meaning node 910. Like the Cognitive Graph of FIG. 9A, the relationship between the first typed meaning node 906 (“Berlin (Entity)”) and the second typed meaning node 908 (“Germany (Entity)”) may be represented with the “is located in” language. The relationship between the first typed meaning node 906 (“Berlin”) and the third typed node 910 (“City (Concept)”) may be represented with the “is an instance of” language.

While FIG. 9B illustrates typed meaning nodes in a Cognitive Graph, FIG. 9C illustrates typed relationship edges in a Cognitive Graph. Typed relationship edges may provide explicit semantic meaning to the natural language relationships between meaning nodes. For example, the relationship between the first typed meaning node 906 (“Berlin (Entity)”) and the second typed meaning node 908 (“Germany (Entity)”) may be represented with the semantic meaning “SpatialRelation: is located in.” The relationship between the first typed meaning node 906 (“Berlin”) and the third typed node 910 (“City (Concept)”) may be represented with the semantic meaning “SemanticRelation: is an instance of.”

In some examples, semantic relationship subtypes may set forth more specific types of relationship between meaning nodes. In some examples, these subtypes may remove ambiguity from a natural language relationship. In some examples, an explicit type hierarchy may be formed, as illustrated in Example 3:

Example 3
SpatialRelation {
IsLocatedIn:
meaning: ‘the first entity is located within the bounds of the second entity’
from: ‘Entity’
to: ‘Entity’
}
SemanticRelation {
IsAnInstanceOf:
meaning: ‘the first entity is an instance of the second entity’
from: ‘Entity’
to: ‘Concept’
}

FIG. 9D is a block diagram illustrating the Cognitive Graph with the explicit type hierarchy illustrated in Example 3. For example, the relationship between the first typed meaning node 906 (“Berlin (Entity)”) and the second typed meaning node 908 (“Germany (Entity)”) may be represented with the explicit type hierarchy “IsLocatedIn.” The relationship between the first typed meaning node 906 (“Berlin”) and the third typed node 910 (“City (Concept)”) may be represented with the explicit type hierarchy “IsAnInstanceOf.”

In some examples, semantic meaning node subtypes may set forth more specific types of meaning node, and may enable schematized attributes. These attributes may be used to capture scalar values that may not otherwise make sense to be represented as their own nodes. Example 4 illustrates such a semantic meaning node subtype:

Example 4
City {
inherits: Entity
meaning: ‘a particular human-populated physical city’
attributes:
- population: number
- surfaceArea: number
}

Using the example associated with FIGS. 9A-9D, the “City” semantic meaning node subtype may comprise the schematized attributes shown in Example 5:

Example 5
Berlin (City)
- population: 3645000
- surfaceArea: 891.8 km²

In some examples, a relationship may be associated with metadata that provides additional information about the relationship, such as its source, confidence, or other contextual information. FIG. 9E illustrates a block diagram of a relationship 912 between a fourth typed node 914 (“Berlin (City)”) and a fifth typed node 916 (“Germany (Country)”). As illustrated in FIG. 9E, the relationship 912 may be represented with the explicit type hierarchy “IsLocatedln.” In some examples, the relationship 912 may comprise metadata 918. In some examples, the metadata 918 may include a source (e.g., Wikipedia) and a confidence score (e.g., 1.0).

### Example Contextualization Process

In operation, the dynamic cognitive context system 300 may receive data such as queries, identify appropriate contextualization of the data, and effectuate accurate and relevant responses from an inference engine or other consuming system. For example, the dynamic cognitive context system 300 may increase specificity and develop accurate context that captures intent based on the methods, systems, and apparatuses described herein. Such context may lead to an inference engine (e.g., a LLM) or other system having better understanding of requests, and being able to provide more accurate and relevant responses or actions thereto.

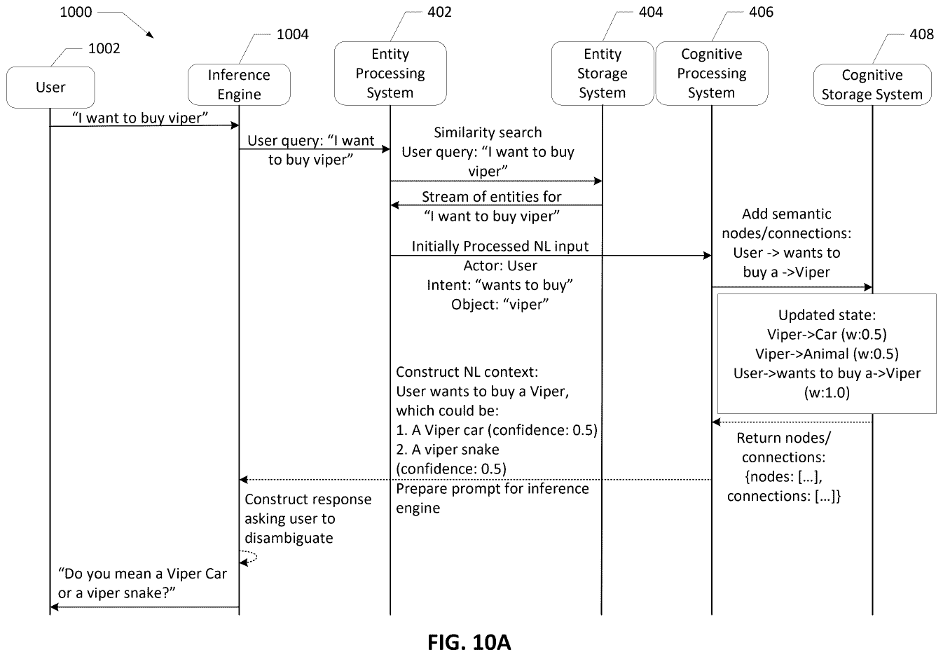

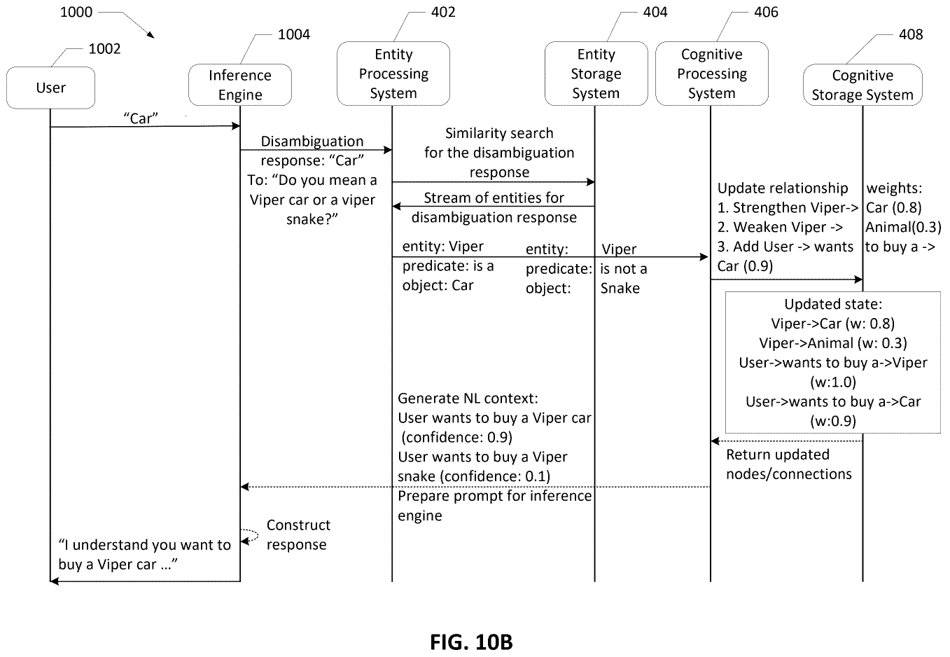

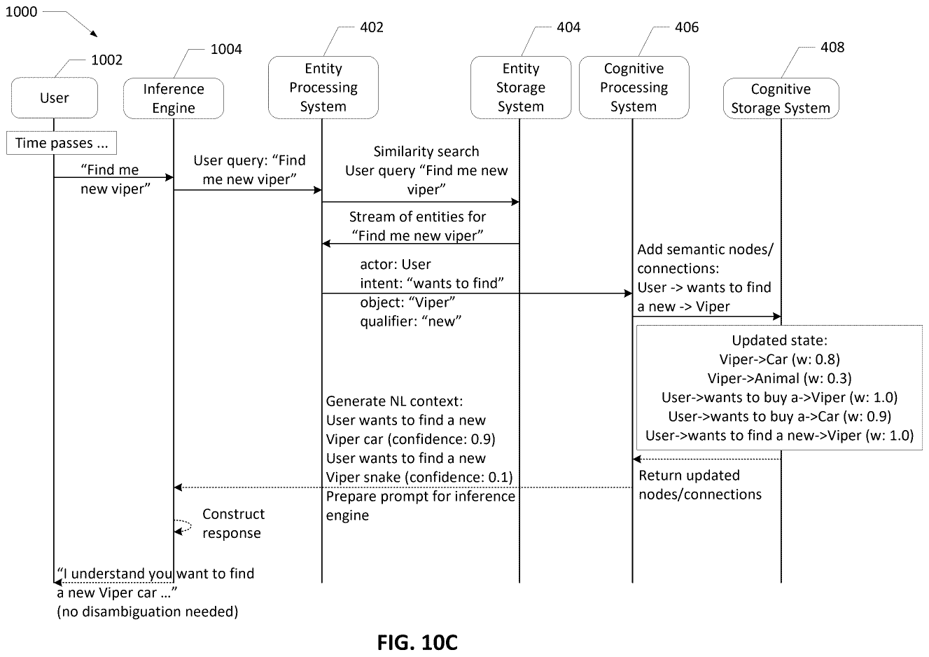

As illustrated in FIGS. 10A-10C, an exemplary contextualization process 1000 performed by the dynamic cognitive context system 300 is shown and described. As shown in FIG. 10A, a user 1002 or other data source may initiate the contextualization process 1000 by submitting data, such as a query, to an inference engine 1004. In some examples, the inference engine 1004 may be a large language model (LLM), API protocol, LLM powered chatbot, retrieval system, search engine, recommendation system, or any other system requiring contextual information. In the illustrated example of FIG. 10A, the data may be the query “I want to buy viper.” The word “viper” on its own may have multiple meanings, many of which may be appropriate in the context of the other words in the query (e.g., “buy”). Therefore, contextualization based on the other words of the query (as performed by a transformer model) may not be sufficient. In some examples, the inference engine 1004 may forward the query (e.g., “I want to buy viper”) to the entity processing system 402. In some examples, the entity processing system 402 may receive the query (e.g., “I want to buy viper”) directly from the user or data source and prior to action upon the query by the inference engine 1004. Thereafter, the example entity processing system 402 may entitize the query by making a call to the entity storage system 404 for the vector representation of each word found within the query. The example entity storage system 404 may store an association between entities and the words within the query. The entity storage system 404 may respond to the entity processing system 402 with a stream of entities matching the query. In some examples, the entity processing system 402 may perform natural language processing on the query and determine that the query should be broken into subject/actor, intent, and object components. In the illustrated example of FIG. 10A, the entity processing system 402 may associate the entities returned from the entity storage system 404 with the subject/actor, intent, and object components as follows: subject/actor: User; intent: want to buy/purchase; and object: viper. The example entity processing system 402 may forward the natural language processed query and entities to the example cognitive processing system 406.

The cognitive processing system 406 may create a semantic mapping by adding semantic nodes and/or connections based on the received natural language processed query and entities. In some examples, the cognitive processing system 406 may remove (block or ignore) nodes and/or connections. In the illustrated example of FIG. 10A, the cognitive processing system 406 may connect a node associated with “User” to a node associated with “buy/purchase.” In some examples, the cognitive processing system 406 may further connect the node associated with “buy/purchase” to a node associated with “viper.” In some such examples, the cognitive processing system 406 may thereby create the semantic mapping: User->wants to buy/purchase a->viper. To the extent that there are multiple nodes associated with the natural language processed query (e.g., “viper” may refer to a type of vehicle or a type of snake), the example cognitive processing system 406 may identify the multiple nodes and determine a weight to be associated with each node. In some examples, the cognitive processing system 406 may check the cognitive storage system 408 for any existing weighting information associated with the nodes. In some examples, the weighting of a node may be determined based on probabilistic functions. In some examples, the weighting of a node may be based on prioritizing common meanings over less common meanings. In some examples, the weighting of a node can be determined based on other words from the query. In some examples (such as a default weighting, when no weighting information exists in the cognitive storage system 408, a query is poorly worded, underdeveloped, or otherwise ambiguous, etc.), the cognitive processing system 406 may equally distribute the weights of the nodes (e.g., the viper vehicle may be given a weight of 0.5 and the viper snake may be given a weight of 0.5). As will be described further below, the cognitive processing system 406 may determine different weights for nodes when multiple node options exist. In some examples, the weighting for the nodes may change over time based on subsequently received information. The cognitive processing system 406 may send these node associations/connections/weights to the cognitive storage system 408 for storage thereof. Upon receipt, the cognitive storage system 408 may update states associated with the various nodes/connections/weights provided by the cognitive processing system 406 (e.g., viper vehicle weighted at 0.5, the viper snake weighted at 0.5, and the entire semantic mapping weighted at 1.0).

The cognitive storage system 408 may return the (updated) states of the various nodes/connections/weights to the cognitive processing system 406 to construct natural language context for the inference engine 1004. For example, the cognitive processing system 406 may construct two different contextual understandings of the query: 1) The User wants to buy a Viper car, and 2) the User wants to buy a viper snake. Based on the illustrated example described above, the cognitive processing system 406 may associate each with a confidence level of 0.5, with each understanding based on the weighting of the nodes. Based on the natural language context, the inference engine 1004 may construct a response to the user 1002 for clarification and disambiguation. For example, the inference engine 1004 may respond to the user 1002 with its own query, such as “Do you mean a Viper car or a viper snake?”

In some examples, the user 1002 or other data source may respond to the query from the inference engine 1004. As illustrated in FIG. 10B, the user 1002 may provide the response “Car.” Based on the response of the user 1002, the inference engine 1004 may forward the response of the user and the clarification or disambiguation response from the inference engine 1004 to the entity processing system 402. Similar to the prior discussion, the entity processing system 402 may entitize the clarification or disambiguation response from the inference engine 1004 by making a call to the entity storage system 404 for the vector representation of each word found within the clarification or disambiguation response from the inference engine 1004. The example entity storage system 404 may respond to the entity processing system 402 with a stream of entities matching the clarification or disambiguation response from the inference engine 1004. The example entity processing system 402 may then associate the entity “Viper” with “car” and “not snake.” The entity processing system 402 may forward these associations to the cognitive processing system 406. Based on these new associations, the example cognitive processing system 406 may determine new weights for the “viper” nodes. In some such examples, the relationship between “viper” and “car” may be strengthened (e.g., based on the entity “Viper” being associated with “car”). For example, the example cognitive processing system 406 may weight the relationship between the node associated with “Viper” and the node associated with a car at 0.8. In some examples, the relationship between “viper” and “snake” may be weakened (e.g., based on the entity “Viper” being associated with “not snake”). For example, the example cognitive processing system 406 may weight the relationship between the node associated with “Viper” and the node associated with a snake at 0.2. Based on these updated weights, the cognitive processing system 406 may create a new semantic mapping connecting the node associated with “User” to the node associated with “buy/purchase,” and the node associated with “car” (e.g., User->wants to buy/purchase a->car). Because the “viper” as a snake is not weighted at 0, the semantic mapping “User->wants to buy/purchase a->car” may not be weighted at a 1. However, the cognitive processing system 406 may determine that the semantic mapping “User->wants to buy/purchase a->car” may be probable (e.g., based on the user's own responses), such that cognitive processing system 406 may determine a high weighting (e.g., 0.9) for the semantic mapping “User->wants to buy/purchase a->car.” The cognitive processing system 406 may send these node associations/connections/weights to the cognitive storage system 408 for storage thereof. Upon receipt, the cognitive storage system 408 may update the states associated with the various nodes/connections/weights provided by the cognitive processing system 406 (e.g., viper vehicle weighted at 0.8, the viper snake weighted at 0.2, the semantic mapping “User->wants to buy/purchase a->viper” weighted at 1.0, and the semantic mapping “User->wants to buy/purchase a->car” weighted at 0.9).

The cognitive processing system 406 may leverage the updated states of the various nodes/connections/weights from the cognitive storage system 408 to generate natural language context for the inference engine 1004. Similar to the discussion above, the cognitive processing system 406 may construct two different contextual understandings of the query: 1) The User wants to buy a Viper car, and 2) the User wants to buy a viper snake. But based on the updated weights, the cognitive processing system 406 may associate the contextual understanding that the user wants to buy a viper car with a confidence level of 0.9. The cognitive processing system 406 may associate the contextual understanding that the user wants to buy a viper snake with a confidence level of 0.1. Based on the higher confidence level of the first contextual understanding (e.g., the user wants to buy a viper car), the inference engine 1004 may construct a response to the user 1002 indicating “I understand you want to buy a Viper car . . . .”

In some examples, where the weighting is substantially high for a given outcome (e.g., User->wants to buy/purchase a->car weighted at 0.9), rather than (or in addition to) constructing a response to the user indicating the understanding of the inference engine 1004 (“I understand you want to buy a Viper car . . . ”), the inference engine 1004 or other consuming system may act (e.g., execute an action) on the query by locating viper cars for sale to facilitate the purchase of a viper car, despite the user not actually requesting the inference engine 1004 to search and find viper cars for sale.

As illustrated in FIG. 10C, some time may pass after the dynamic cognitive context system 300 contextualizes the query “I want to buy viper.” At a subsequent time, the user 1002 (or any other user or system) may initiate a new query “Find me new viper.” In some examples, the new query of the user 1002 (or other source) may be passed directly to the entity processing system 402. The example entity processing system 402 may entitize the new query by making a call to the entity storage system 404 for the vector representation of each word found within the new query. The example entity storage system 404 may respond to the entity processing system 402 with a stream of entities matching the new query. In some examples, the entity processing system 402 may perform natural language processing on the new query and determine that the new query should be broken into subject/actor, intent, object, and qualifier components. In the illustrated example of FIG. 10C, the entity processing system 402 may associate the entities returned from the entity storage system 404 with the subject/actor, intent, object, and qualifier components as follows: subject/actor: User; intent: want to find; object: viper; qualifier: new. The example entity processing system 402 may forward the natural language processed new query and entities to the example cognitive processing system 406.

The cognitive processing system 406 may update the semantic mapping by establishing, adding, removing, ignoring, blocking, or otherwise adjusting semantic nodes and/or connections based on the received natural language processed new query and entities. In the illustrated example of FIG. 10C, the cognitive processing system 406 may connect the node associated with “User” to a node associated with “want to find new,” and to the node associated with “viper,” thereby creating the semantic mapping: User->wants to find a new->viper. In some examples, the cognitive processing system 406 may check the cognitive storage system 408 for any existing weighting information associated with the nodes. In the illustrated example of FIG. 10C, the cognitive storage system 408 may store the following states: viper vehicle weighted at 0.8, the viper snake weighted at 0.2, the semantic mapping “User->wants to buy/purchase a->viper” weighted at 1.0, and the semantic mapping “User->wants to buy/purchase a->car” weighted at 0.9. In some examples, the cognitive storage system 408 may further store the semantic mapping “User->wants to find a new->viper” weighted at 1.0.

The cognitive processing system 406 may leverage these states of the various nodes/connections/weights from the cognitive storage system 408 to generate natural language context for the inference engine 1004. Similar to the discussion above, the cognitive processing system 406 may construct two different contextual understandings of the query: 1) The User wants to find a new Viper car, and 2) the User wants to find a new viper snake. Based on the states within the cognitive storage system 408, the cognitive processing system 406 may associate the contextual understanding that the user wants to find a new viper car with a confidence level of 0.9. The cognitive processing system 406 may associate the contextual understanding that the user wants to find a new viper snake with a confidence level of 0.1. Based on the higher confidence level of the first contextual understanding (e.g., the user wants to find a new viper car), the inference engine 1004 may construct a response to the user 1002 indicating “I understand you want to find a new Viper car . . . .”

In some examples, where the weighting is substantially high for a given outcome (e.g., user wants to find a new viper car weighted at 0.9), rather than (or in addition to) constructing a response to the user indicating understanding of the inference engine 1004, the inference engine 1004 or other consuming system may act (e.g., execute an action) on the query by searching for new viper cars for sale, despite the user not specifically requesting the inference engine 1004 to search for new viper cars for sale.

While the example contextualization process 1000 is illustrated in FIGS. 10A-10C with two queries (e.g., an initial query and a new query), the contextualization process 1000 may be performed continuously for any data or any number of queries from any number of users or systems. Indeed, the methods, systems, and apparatuses disclosed herein are intended to continuously update the weighting of various relationships over time based on all interactions. In some examples, because the methods, systems, and apparatuses disclosed herein continuously update the weighting of various relationships over time based on all interactions, a first implementation of the methods, systems, and apparatuses disclosed herein in one location with one set of users or systems may differ significantly from a second implementation of the methods, systems, and apparatuses disclosed herein in another location and/or with another set of users or systems.

While user queries are illustrated in the example contextualization process 1000 illustrated in FIGS. 10A-10C, any data may be used as noted above. For example, audio, textual, haptic, image, and/or video data may be contextualized according to the example contextualization process 1000. In some examples, the example contextualization process 1000 may be performed by multiple instances of the dynamic cognitive context system 300 operating in parallel, in series, or in a combination thereof.

### Entification Process

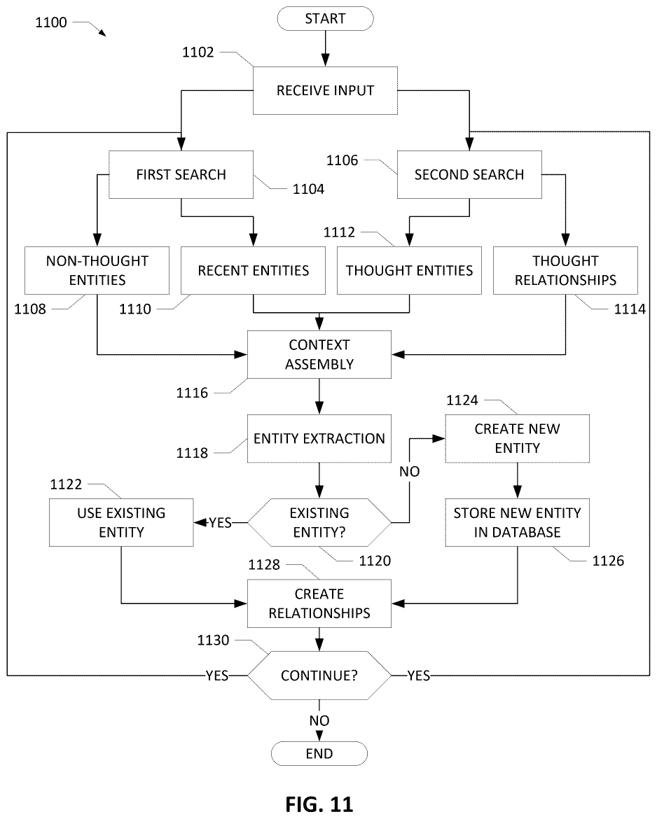

FIG. 11 illustrates a flowchart implementing a method 1100 for the entification of data, such as a query (e.g., the query “I want to buy viper” from FIG. 10A). The method 1100 of FIG. 11 may determine entities and relationships from the data and return the determined entities and relationships. In some examples, the entity processing system 402 may implement the method 1100 in connection with the entity storage system 404. For example, the method 1100 may implement the exchange between the entity processing system 402 and the entity storage system 404 illustrated in FIGS. 10A-10C (e.g., similarity search returning stream of entities).

The example method 1100 may begin by receiving input data (step 1102). From there, a first search (step 1104) and a second search (step 1106) may be implemented. In some examples, the first search may comprise performing similarity searches with non-thought entities (step 1108) and recent entities (step 1110). In some examples, the second search may comprise performing similarity searches with thought entities (step 1112) and thought relationships (step 1114). After the first search and the second search, the entity processing system 402 may assemble together the context (step 1116). In some examples, the entity processing system 402 may create search context for vector searching of related entities. Thereafter, the entity processing system 402 may extract entities (step 1118).

In some examples, the entity processing system 402 may prompt an inference engine to extract entities from data segments. In some examples, the entity processing system 402 may parse structured entities from one or more responses from the inference engine. In some examples, the entity processing system 402 may check for existing entities (step 1120). In some examples, the entity processing system 402 may check for existing entities using vector similarity. If the entity processing system 402 determines there is one or more existing entities (step 1120: YES), the entity processing system 402 may determine to use the one or more existing entities in future steps (step 1122). If the entity processing system 402 determines there is no matching existing entities (step 1120: NO), the entity processing system 402 may create one or more new entities (step 1124). In some examples, the entity processing system 402 may store the one or more newly created entities in the entity storage system 404 and/or the cognitive storage system 408 (step 1126). Although steps 1122 and 1124-1126 are illustrated as alternative paths to step 1120, because there may be some existing entities and some new entities, it is possible that all steps 1122-1126 may be performed (either serially or in parallel). At step 1128, the entity processing system 402 may create relationships between the one or more existing entities and/or the one or more newly created entities. In some examples, the method 1100 may determine whether to continue this process (e.g., such as after receipt of additional input data) (step 1130). If the process is to continue (step 1130: YES), then control may return to steps 1104 and 1106, respectively. Otherwise (step 1130: NO), the method 1100 may cease.

### Weight Visualization and Adjustment

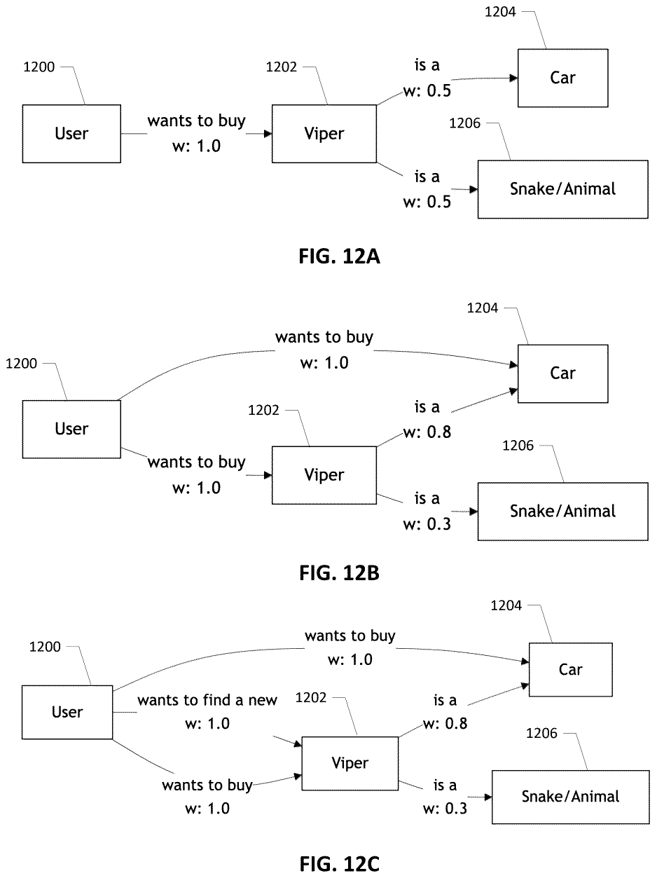

FIGS. 12A-12C further illustrate the weighting described with respect to FIGS. 10A-10C. For example, a user or system who submits a query indicating a desire to buy a viper may be represented by a user node 1200 and a viper node 1202. The example cognitive processing system 406 may connect the user node 1200 and the viper node 1202 to form a relationship. As discussed above, the relationship between user node 1200 and viper node 1202 may be “wants to buy” (e.g., user wants to buy viper). Because this relationship may be substantially similar to the query, the example cognitive processing system 406 may weight the relationship between user node 1200 and viper node 1202 at 1.0.

Because the word “viper” may have multiple meanings, each meaning may be represented with its own node and relationship. For example, the example cognitive processing system 406 may create a car node 1204 and a snake/animal node 1206. Additionally, the example cognitive processing system 406 may create a first relationship between the viper node 1202 and the car node 1204. Similarly, the example cognitive processing system 406 may create a second relationship between the viper node 1202 and the snake/animal node 1206. Without any additional context, the example cognitive processing system 406 may weight the relationships between viper node 1202 and car node 1204 and between viper node 1202 and snake/animal node 1206 equally. If there are X meanings, the weighting may be 1/X. In the illustrated example of FIGS. 10A-10C & 12A-12C, because there are two meanings of viper, the initial weighting of the relationship between viper node 1202 and car node 1204 may be 0.5 (½). Similarly, the relationship between viper node 1202 and snake/animal node 1206 may be 0.5 (½). In some examples, an equal initial weighting may be appropriate. However, in some examples, an equal initial weighting may not be appropriate. In some such examples, additional information from the query, a context window, or external sources may be leveraged to appropriately distribute the initial weighting.

Regardless of the initial weighting, over time the dynamic cognitive context system 300 may be exposed to new information for which the dynamic cognitive context system 300 will assess and adjust the relationship weighting of nodes. As in the illustrated example described with reference to FIGS. 10A-10C, a user or system may have indicated a desire to buy a viper and later indicate that a viper vehicle/car was meant. In some examples, the example cognitive processing system 406 may adjust the weighting of the relationships between the nodes appropriately. As shown in FIG. 12B, the example cognitive processing system 406 may adjust the weight of the first relationship between the viper node 1202 and the car node 1204 from 0.5 to 0.8 based on the subsequent interaction described with reference to FIGS. 10A-10C. Similarly as shown in FIG. 12B, the example cognitive processing system 406 may adjust the weight of the second relationship between the viper node 1202 and the snake/animal node 1206 from 0.5 to 0.2.

As shown in FIG. 12C, upon a subsequent interaction with the user 1200 or system, the example cognitive processing system 406 may connect the user node 1200 and the viper node 1202 and form a new relationship. As discussed above, the new relationship between user node 1200 and viper node 1202 may be “wants to find a new” (e.g., find me new viper). Because this relationship may be substantially similar to the subsequent query, the example cognitive processing system 406 may weight the new relationship between user node 1200 and viper node 1202 at 1.0.

Over time the example cognitive processing system 406 may adjust the weights of these relationships so that the dynamic cognitive context system 300 is constantly updating the context of the relationships between nodes. This weight adjustment may not be user-specific or system-specific and may be updated based on subsequent interactions with the same user or system, based on interactions with numerous users or systems, based on subsequent interactions with the same numerous users or systems, and the like. For example, if the user 1200 or system or some other user, system, or set of users/systems create new queries focusing on viper snakes, the example cognitive processing system 406 may adjust the weights of the relationships between the viper node 1202 and the car node 1204 and between the viper node 1202 and the snake/animal node 1206 appropriately. Indeed, it is feasible that the example cognitive processing system 406 may adjust the weight of the relationship between the viper node 1202 and the car node 1204 to be at 0.2 and adjust the weight of the relationship between the viper node 1202 and the snake/animal node 1206 to be 0.8.

In some examples, a determination that a relationship should be weighted a certain way may be temporally limited. For example, the term “trending” may be used to refer to topics, media, etc. that is currently (un)popular or forms a collective (dis)interest of a population. Such topics, media, etc. may form or be part of a small or large amount of queries at or around a first time. Such topics, media, etc. may form or be part of more or less queries at or around a second time. Therefore, in some examples, the weights of relationships formed by the example cognitive processing system 406 may be configured to decay or otherwise return to the initial weighting over time to accommodate changes in the collective (dis)interest of the population or changes in usage patterns.

### Advanced Features

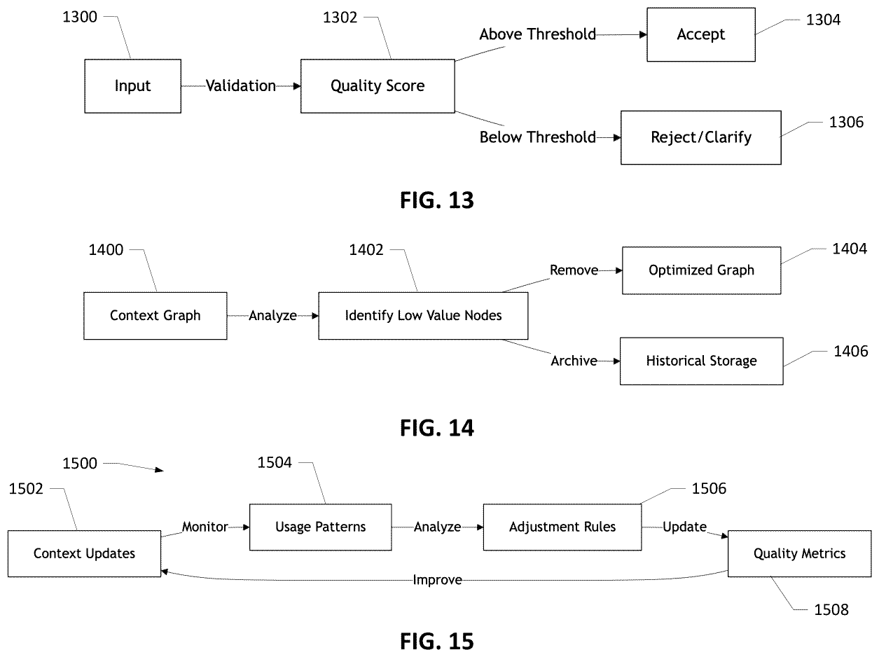

FIGS. 13-15 illustrate a number of advanced features of the dynamic cognitive context system 300. For example, the example entity processing system 402 and the example cognitive processing system 406 were described above as being capable of performing confidence scoring, context pruning, and validation feedback loops.

FIG. 13 is a block diagram illustrating an example confidence scoring sequence. For a given input 1300, either the example entity processing system 402 or the example cognitive processing system 406 may perform validation as to the input quality based on a number of factors. For example, the example entity processing system 402 or the example cognitive processing system 406 may validate the quality of an input based on semantic coherence, contextual relevance, source reliability, and pattern matching confidence. Based on validating the quality of the input, example entity processing system 402 or the example cognitive processing system 406 may assign a quality score 1302. The quality score 1302 may be a numerical score between zero and one. The example entity processing system 402 or the example cognitive processing system 406 may compare the quality score 1302 to a threshold to determine whether to accept or reject/clarify the input. In some examples the threshold may be configurable. If the quality score 1302 is greater than or equal to the threshold, the example entity processing system 402 or the example cognitive processing system 406 may accept 1304 the input. If the quality score 1302 is lower than the threshold, the example entity processing system 402 or the example cognitive processing system 406 may reject/clarify 1306 the input.

In some examples, the example entity processing system 402 or the example cognitive processing system 406 may perform conflict resolution when contradictory relationships are detected. In some such examples, the example entity processing system 402 or the example cognitive processing system 406 may compare the confidence scores of the contradictory relationships. In some examples, the example entity processing system 402 or the example cognitive processing system 406 may compare the contradictory relationships to a threshold. In some examples, the example entity processing system 402 or the example cognitive processing system 406 may compare the contradictory relationships to each other. The example entity processing system 402 or the example cognitive processing system 406 may determine which of the contradictory relationships have higher confidence scores and/or were created most recently. In some such examples, relationships having higher confidence scores or were created recently may be prioritized. In some examples, the example entity processing system 402 or the example cognitive processing system 406 may consider historical patterns, user or system context, preferences, and domain expertise level. In some examples, the example entity processing system 402 or the example cognitive processing system 406 may apply domain-specific rules, custom logic for known edge cases, industry-specific relationship hierarchies, and semantic compatibility checks. In some examples multiple high confidence conflicts may trigger disambiguation, such that the example entity processing system 402 or the example cognitive processing system 406 may signal an inference engine or consuming system to request disambiguation or clarification.

As described above, the example cognitive processing system 406 may perform system validations of Cognitive Graphs. An example system validation may comprise context pruning, which is shown and described with respect to FIG. 14. The example cognitive processing system 406 may analyze a Cognitive Graph 1400 to identify low value nodes 1402. Upon determining or identifying low value nodes 1402, the example cognitive processing system 406 may either remove, block, ignore, or archive the low value nodes 1402. In some examples, the cognitive processing system 406 may remove (block or ignore) a low value node 1402 to maintain graph efficiency and relevance, thereby creating an optimized Cognitive Graph 1404. In some examples the cognitive processing system 406 may archive the low value nodes 1402 for later reference in a historical storage 1406. In some examples the historical storage 1406 may be located within the cognitive storage system 408. In some examples, the context pruning may be performed periodically or according to a configurable schedule. In some examples, the criteria for determining a low value node 1402 may be configurable as well.

In some examples the cognitive processing system 406 may perform a validation feedback loop 1500, as illustrated in FIG. 15. In some examples, the cognitive processing system 406 may continuously monitor context quality. In some examples, the cognitive processing system 406 may adapt validation rules based on outcomes. In some examples, the cognitive processing system 406 may improve accuracy over time through learning. In some examples, the cognitive processing system 406 may provide insights for system optimization. For example, the cognitive processing system 406 may monitor context updates 1502 for usage patterns 1504. The example cognitive processing system 406 may analyze usage patterns 1504 to determine adjustment rules 1506. Based on the adjustment rules 1506, the example cognitive processing system 406 may update quality metrics 1508. The example cognitive processing system 406 may use the example updated quality metrics 1508 to create improved context updates 1502.

### Computing Device Implementation

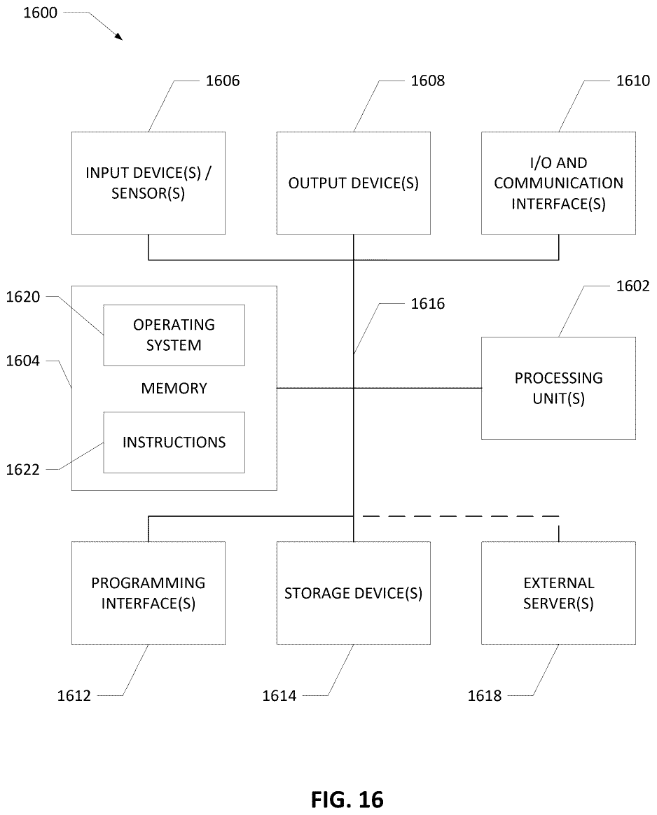

FIG. 16 illustrates an example computing device 1600 that may be used in accordance with the teachings described herein. The example computing device 1600 may be a computer, a tablet, a mobile device, a server, a workstation, an internet-of-things (IoT) device, a smart appliance, a network node, a hub, a router, a modem, or the like. The example computing device 1600 may comprise one or more processing units 1602, one or more memory 1604, one or more input devices or sensors 1606, one or more output devices 1608, one or more input/output (I/O) and communication interfaces 1610, one or more programming interfaces 1612, and one or more storage devices 1614. Each of the one or more processing units 1602, one or more memory 1604, one or more input devices or sensors 1606, one or more output devices 1608, one or more input/output (110) and communication interfaces 1610, one or more programming interfaces 1612, and one or more storage devices 1614 may be interconnected via wired connections such as, for example, a bus 1616. Alternatively, each of the one or more processing units 1602, one or more memory 1604, one or more input devices or sensors 1606, one or more output devices 1608, one or more input/output (110) and communication interfaces 1610, one or more programming interfaces 1612, and one or more storage devices 1614 may be interconnected wirelessly. In some examples, each of the one or more processing units 1602, one or more memory 1604, one or more input devices or sensors 1606, one or more output devices 1608, one or more input/output (110) and communication interfaces 1610, one or more programming interfaces 1612, and one or more storage devices 1614 may be interconnected via a combination of wired and wireless connections. In some examples, the example computing device 1600 may be connected to one or more external servers 1618.

In some examples, the processing unit 1602 may be circuitry or a device configured for processing data. The processing unit 1602 may be a processor such as a central processing unit (CPU), a microprocessor, integrated circuit (IC), an application-specific integrated circuit (ASIC), a Field Programmable Gate Array (FPGA), a graphical processing unit (GPU), a quantum processor, a bioprocessor, a vector processor, a graph processor, or the like. In some examples, the computing device 1600 may have one or more processing units 1602 for parallel processing. In some such examples, the one or more processing units 1602 may be of the same type (e.g., multiple microprocessors). In some examples, the one or more processing units 1602 may be of different types (e.g., at least one CPU and at least one GPU). In some examples, the entity processing system 402, the cognitive processing system 406, and/or the execution processing system 410 may be implemented by the processing unit 1602.

In some examples, the memory 1604 may be a non-transitory computer readable storage medium. In some examples, the memory 1604 may include random-access memory, such as DRAM, SRAM, DDR RAM, or other random-access solid-state memory devices. In some examples, the memory 1604 may include an operating system 1620 and instructions 1622.

The operating system 1620 may be a traditional operating system that relies on pre-defined rules and structures such as, for example, Microsoft Windows®, Linux, macOS, etc. The instructions 1622 may comprise computer executable instruction sets for implementing the exemplary contextualization process 1000 described above with reference to FIGS. 10A-10C, the entification method 1100, weight adjustment algorithms, confidence scoring, context pruning, validation feedback loops, and other operations of the dynamic cognitive context system 300.

In some examples, the one or more input devices or sensors 1606 may comprise one or more image/video sensors (e.g., cameras), one or more accelerometers, one or more gyroscopes, one or more thermometers, one or more physiological sensors, one or more microphones, a signal receiver, a haptics engine, a gesture-recognition engine, one or more depth sensors, a keyboard, a numeric pad, a mouse, a touchscreen, a trackpad, or the like.

In some examples, the one or more output devices 1608 may comprise one or more displays, one or more speakers, one or more lights (e.g., light emitting diodes), a signal generator, a haptics engine, a printer, or the like.

In some examples, the one or more I/O and communication interfaces 1610 may comprise USB, FIREWIRE, THUNDERBOLT, WI-FI, IEEE 802.3x, IEEE 802.11x, IEEE 802.16x, GSM, CDMA, TDMA, GPS, IR, BLUETOOTH, ZIGBEE, SPI, I2C, or a similar type of interface.

In some examples, the one or more programming interfaces 1612 may comprise software for implementing one or more physical I/O and communication interfaces, application programming interfaces (APIs) configured for communication with and providing services to storage systems, databases, software applications, the Internet, or the like.

In some examples, the one or more storage devices 1614 may comprise non-volatile memory, such as one or more magnetic disk storage devices, optical disk storage devices, flash memory devices, or other non-volatile solid-state storage devices. In some examples, the one or more storage devices 1614 may include one or more storage systems or databases. For example, the one or more storage devices 1614 may comprise the entity storage system 404 (which may comprise the vector embedding storage system 600 and the vector collection storage system 602) and the cognitive storage system 408 (which may comprise the meaning node storage system 800 and the relationship edges storage system 802).

In some examples, the one or more external servers 1618 may comprise external processing and storage that may be utilized by the example computing device 1600. In some examples, the one or more external servers 1618 may be configured similarly to the example computing device 1600. In some examples, the one or more external servers 1618 may be connected to the example computing device 1600 via a local area network (LAN). In some examples, the one or more external servers 1618 may be connected to the example computing device 1600 via a wireless network. In some examples, the one or more external servers 1618 may be connected to the example computing device 1600 via the Internet.

The dynamic cognitive context system 300 may be deployed in various configurations to suit different operational requirements and infrastructure environments. In some examples, the dynamic cognitive context system 300 may be deployed as a cloud-based service, enabling distributed processing across multiple geographic regions and providing scalable resource allocation based on demand. In some examples, the dynamic cognitive context system 300 may be deployed in a hybrid configuration, with certain components operating on-premises while other components operate in cloud environments. In some examples, the dynamic cognitive context system 300 may support containerized deployment using technologies such as Docker or Kubernetes, enabling consistent operation across diverse computing environments. In some examples, the dynamic cognitive context system 300 may be deployed in distributed configurations where the entity storage system 404 and cognitive storage system 408 are partitioned or replicated across multiple nodes to improve fault tolerance and query performance. Such deployment flexibility may allow organizations to optimize the dynamic cognitive context system 300 for their specific requirements regarding latency, data sovereignty, scalability, and cost.

### Additional Embodiments

One or more example apparatus, systems, and computer-readable storage mediums are described below. An example method may comprise receiving, from a first neuron of a neural network, non-deterministic data. The example method may comprise dynamically generating, based on an entity storage system and based on the non-deterministic data, units of information. The example method may comprise processing, via a graph processor, the dynamically generated units of information to form a semantic mapping. In some examples, the semantic mapping may comprise nodes interconnected according to relationships weighted based on probability, context within the non-deterministic data, and historical interactions between one or more devices.

An example method may comprise receiving, from a first device, a query. The method may further comprise entitizing, via a vector processor, the query. The method may further comprise processing, via a graph processor, the entitized query to form a semantic mapping, wherein the semantic mapping comprises nodes interconnected according to relationships weighted based on probability, context within the query, and historical interactions with the first device and a second device. In some examples, the method may further comprise outputting the semantic mapping.

An example method may comprise receiving, from a first device, a query. The method may further comprise determining, via a processor, a vector representation of the query. The method may further comprise determining, via the processor and based on the vector representation, a semantic mapping of the query, wherein the semantic mapping comprises nodes interconnected according to relationships weighted based on probability, context within the query, and historical interactions with the first device and a second device. In some examples, the method may further comprise outputting the semantic mapping.

An example method may comprise receiving, from a first device, first data. The method may further comprise determining, via a processor, a vector representation of the first data. The method may further comprise determining, via the processor and based on the vector representation, a semantic mapping of the first data, wherein the semantic mapping comprises nodes interconnected according to relationships weighted based on probability, context associated with the first data, and historical interactions with the first device and a second device. In some examples, the method may further comprise outputting the semantic mapping.

One or more methods may further comprise outputting the sematic mapping to a large language model.

One or more methods may further comprise receiving, from the large language model, a response to the query based on the semantic mapping.

In one or more methods, the historical interactions with the first device and the second device may comprise every interaction with the first device and at least one interaction with the second device.

One or more methods may further comprise receiving, from the first device, a second query, entitizing, via the vector processor, the second query, adjusting, via the graph processor and based on the second entitized query, the weighted relationships of the semantic mapping to form an updated semantic mapping, and outputting the updated semantic mapping.

One or more methods may further comprise creating a response to the query requesting disambiguation, and transmitting the response to the first device, wherein receiving, from the first device, the second query is in response to transmitting the response to the first device.

In one or more methods, the entitizing, via the vector processor, of the query may comprise accessing a storage system to receive a vector representation of each word within the query.

In one or more methods, the entitizing, via the vector processor, of the query may comprise transmitting the query to a storage system, and receiving, from the storage system, a stream of entities matching the query.

In one or more methods, the processing, via the graph processor, of the entitized query to form the semantic mapping may comprise creating new nodes or creating new connections between existing nodes.

In one or more methods, the processing, via the graph processor, of the entitized query to form the semantic mapping may comprise updating states within a storage system representing nodes or connections.

One or more methods may further comprise adjusting, based on temporal decay, the weighted relationships of the semantic mapping to form an updated semantic mapping.

In one or more methods, the query comprises non-deterministic data.

Example apparatuses, computer readable storage mediums, and systems may be configured to implement the one or more methods described above.

Example apparatuses or systems may comprise one or more processors and memory storing instructions, that when executed by the one or more processors, cause the apparatuses or systems to implement the one or more methods described above. Likewise, computer readable storage mediums may store instructions that when executed cause performance of the one or more methods described above.

An example system may comprise a first neural network including cognitive neuron interconnected by edges having multidimensional weights. In some examples, the multidimensional weights may include rational, emotional, or temporal weights. The first neural network may be configured to manage the edges/connections between neurons. The example system may comprise a second neural network including execution neurons represented as graph nodes configured to receive data, convert, based on a schema, the data into structured representations, receive outputs from the first neural network, generate prompts for inference systems, and selectively route outputs. In some examples, the execution neurons may comprise entity metadata. The example system may comprise a third neural network including entity neurons positioned in vector space based on semantic similarity. In some examples, the entity neurons may represent deterministic entities distilled from non-deterministic inputs. In some examples the second neural network may request contextual pathways from the first neural network. In some examples, the first neural network may stabilize context using the third neural network. In some examples, the third neural network may anchor semantic entities for the first neural network. In some examples, the first neural network may be associated with a weight decay function to deemphasize stale connections. In some examples, the entity neurons may be updated by funneling non-deterministic inputs into deterministic vector positions.

An example system may comprise a first neuron of a neural network and a second neuron of the neural network. In some examples, the first neuron may be configured to receive data, determine, via a first processor, a vector representation of the data, determine, via the first processor and based on the vector representation, a semantic mapping of the data, wherein the semantic mapping comprises nodes interconnected according to relationships weighted based on probability, context associated with the data, and historical interactions with one or more devices, transmit the semantic mapping to an inference engine, receive, from the inference engine, a response based on the semantic mapping, and transmit the response to the second neuron. In some examples, the second neuron may be configured to receive, from the first neuron, the response, execute, via a second processor, an action based on the response.

An example system comprise a first neuron of a neural network, a second neuron of the neural network, and a third neuron of the neural network. In some examples, the first neuron may be configured to receive, from a first device, first data, determine, via a first processor, a first vector representation of the first data, determine, via the first processor and based on the first vector representation, a first semantic mapping of the first data, wherein the first semantic mapping comprises nodes interconnected according to relationships weighted based on probability, context associated with the first data, and historical interactions with the first device and a second device, transmit the first semantic mapping to a first inference engine, receive, from the first inference engine, a first response based on the first semantic mapping, and transmit the first response to the third neuron. In some examples, the second neuron is configured to receive, from the second device, second data, determine, via a second processor, a second vector representation of the second data, determine, via the second processor and based on the second vector representation, a second semantic mapping of the first data, wherein the second semantic mapping comprises nodes interconnected according to relationships weighted based on probability, context associated with the first data, and historical interactions with the first device and the second device, transmit the second semantic mapping to a second inference engine, receive, from the second inference engine, a second response based on the second semantic mapping, and transmit the second response to the third neuron. In some examples, the third neuron is configured to receive, from the first neuron, the first response, receive, from the second neuron, the second response, determine, via a third processor, a third vector representation of the first response, determine, via the third processor, a fourth vector representation of the second response, determine, via the third processor and based on the third vector representation and the fourth vector representation, a third semantic mapping of the first response and the second response, wherein the third semantic mapping comprises nodes interconnected according to relationships weighted based on probability, context associated with the first response and the second response, and historical interactions with the first device and the second device, transmit the third semantic mapping to a third inference engine, receive, from the third inference engine, a third response based on the second semantic mapping, and output the third response.

Another example system may comprise a first neuron of a first neural network configured to receive data, a vector processor configured to determine based on the data, one or more entities, and a graph processor configured to generate, based on the one or more entities, a probability distribution, context associated the data, and historical interactions between the first neural network and a device, one or more semantic mappings comprising nodes interconnected according to weighted relationships, and update, based on at least one of additional data, context, or interactions, the one or more semantic mappings.

In some systems, the graph processor may be further configured to output the one or more semantic mappings to a large language model.

In some systems, the vector processor may be configured to receive, from the large language model, a response based on the one or more semantic mappings.

In some systems, the historical interactions may comprise every interaction with the first neural network, and at least one interaction with the device.

In some systems, the vector processor may be further configured to receive, from the device, second data, determine, based on the second data, one or more second entities, and the graph processor may be further configured to adjust, based on the one or more second entities, the weighted relationships of the one or more semantic mappings, and output the updated one or more semantic mappings.

In some systems, the graph processor may be further configured to generate natural language context; and transmit the generated natural language context to an inference engine, which may be configured to construct a response to the data requesting disambiguation, and transmit the response to the device. In some examples, the vector processor may be further configured to receive, from the device, the second data in response to transmission of the response to the device.

In some systems, to determine the one or more entities, the vector processor may be configured to access a storage system to receive a vector representation of the data.

In some systems, to determine the one or more entities, the vector processor may be configured transmit the data to a storage system, and receive, from the storage system, a stream of entities matching the data.

In some systems, to generate the one or more semantic mappings, the graph processor may be configured to create new nodes or new connections between existing nodes.

In some systems, to generate the one or more semantic mappings, the graph processor may be configured to update states within a storage system representing nodes or connections.

In some systems, to update the one or more semantic mappings, the graph processor may be further configured to adjust, based on temporal decay, the weighted relationships of the one or more semantic mapping.

In some systems, the data may comprise non-deterministic data.

Another example system may comprise an input interface configured to receive data, an entity processing system configured to determine, based on the data, one or more entities; and a cognitive processing system configured to: generate, based on the one or more entities, a probability distribution, context associated with the data, and historical interactions, one or more semantic mappings comprising nodes interconnected according to weighted relationships; and update, based on at least one of additional data, context, or interactions, the one or more semantic mappings, wherein the entity processing system and cognitive processing system are configured to operate coherently via an integration layer maintaining synchronized state between vector operations and graph updates to regenerate context in real-time by dynamically constructing semantic mappings rather than retrieving pre-existing contextual information.

In some systems, the cognitive processing system is further configured to output the one or more semantic mappings to an inference engine.

In some systems, the entity processing system is configured to receive, from the inference engine, a response based on the one or more semantic mappings.

In some systems, the historical interactions comprise interactions with one or more devices or systems.

In some systems, the entity processing system is further configured to: receive, from a source, second data, determine, based on the second data, one or more second entities, and the cognitive processing system is further configured to adjust, based on the one or more second entities, the weighted relationships of the one or more semantic mappings, and output the updated one or more semantic mappings.

In some systems, the cognitive processing system is further configured to generate natural language context, and transmit the generated natural language context to an inference engine.

In some systems, the inference engine is configured to construct a response to the data requesting disambiguation, and transmit the response to the source.

In some systems, the entity processing system is further configured to receive, from the source, the second data in response to transmission of the response to the source.

In some systems, wherein to determine the one or more entities, the entity processing system is configured to access a storage system to receive a vector representation of the data.

In some systems, wherein to determine the one or more entities, the entity processing system is configured to transmit the data to a storage system, and receive, from the storage system, entities matching the data.

In some systems, wherein to generate the one or more semantic mappings, the cognitive processing system is configured to create new nodes or new connections between existing nodes.

In some systems, wherein to generate the one or more semantic mappings, the cognitive processing system is configured to update states within a storage system representing nodes or connections.

In some systems, wherein to update the one or more semantic mappings, the cognitive processing system is further configured to calculate a decay factor based on an exponential function applied to elapsed time since last interaction with a weighted relationship, multiply a current weight of the weighted relationship by the decay factor to generate an updated weight, and adjust, based on temporal decay, the weighted relationships of the one or more semantic mappings by storing the updated weight, wherein the exponential function comprises a configurable decay rate parameter.

In some systems, wherein the data comprises non-deterministic data.

Another system may comprise one or more processors and memory storing instructions that, when executed, cause performance of receiving data, determining, based on the data, one or more entities, processing, based on a probability distribution, context associated with the data, and historical interactions, the one or more entities to form one or more semantic mappings comprising nodes interconnected according to weighted relationships, and updating, based on at least one of additional data, context, or interactions, the one or more semantic mappings.

In some systems, the updating the one or more semantic mappings comprises receiving, from a source, second data, determining, based on the second data, one or more second entities, adjusting, based on the one or more second entities, the weighted relationships of the semantic mappings, and outputting the updated one or more semantic mappings.

In some systems, the instructions, when executed, further cause performance of creating a response to the data requesting disambiguation, and transmitting the response to a source, wherein receiving, from the source, the second data is in response to transmitting the response to the source.

In some systems, the determining, based on the data, the one or more entities comprises accessing a storage system to receive a vector representation of the data.

In some systems, the data comprises non-deterministic data.

In some systems, the updating the one or more semantic mappings comprises adjusting, based on temporal decay, the weighted relationships of the one or more semantic mappings.

In some systems, generating the one or more semantic mappings comprises creating new nodes or new connections between existing nodes.

Another system comprises one or more processors and memory storing instructions that, when executed by the one or more processors, cause receiving data, determining, based on the data, one or more entities, processing, based on a probability distribution, context associated with the data, and historical interactions, the one or more entities to form one or more semantic mappings comprising nodes interconnected according to weighted relationships, and updating, based on at least one of additional data, context, or interactions, the one or more semantic mappings.

In some systems, an integration layer is configured to translate vector operations performed by the entity processing system into graph updates for the cognitive processing system, synchronize state between vector representations and graph representations, and maintain coherence between the entity processing system and the cognitive processing system during real-time updates.

In some systems, the cognitive processing system is further configured to assign a quality score to input data based on at least one of semantic coherence, contextual relevance, source reliability, or pattern matching confidence, compare the quality score to a threshold, and accept the input data when the quality score meets or exceeds the threshold, or signal for disambiguation when the quality score is below the threshold.

In some systems, the historical interactions comprise interactions from multiple users or multiple systems, and the one or more semantic mappings are updated based on aggregated patterns across the interactions from the multiple users or the multiple systems.

In some systems, the data comprises multimodal data including at least two of text data, image data, or audio data, and wherein the entity processing system is configured to generate vector representations for each modality and integrate the vector representations from multiple modalities into unified semantic entities.

In some systems, the weighted relationships comprise multi-dimensional weights including at least two of a rational dimension weight representing logical or factual strength of the relationship, an emotional dimension weight representing affective or sentiment-based strength of the relationship; or a temporal dimension weight representing recency or time-based relevance of the relationship.

In some systems, the rational dimension weight represents logical or factual strength of the relationship based on verified information sources or deterministic reasoning.

In some systems, the emotional dimension weight represents affective or sentiment-based strength of the relationship based on emotional context, user sentiment, or social dynamics.

In some systems, the temporal dimension weight represents recency or time-based relevance of the relationship based on elapsed time since relationship creation or last reinforcement.

In some systems, the integration layer is further configured to detect conflicts between vector representations and graph representations during synchronization, determine, for each detected conflict, a resolution strategy based on at least one of confidence scores, temporal recency, or source reliability, and apply the resolution strategy to maintain consistency between the entity processing system and the cognitive processing system.

In some systems, the inference engine is configured to iteratively request disambiguation across multiple interaction cycles until confidence levels for the one or more semantic mappings exceed a disambiguation threshold, the cognitive processing system is configured to preserve context across the multiple interaction cycles, and the entity processing system is configured to track cumulative clarifications from the multiple interaction cycles to refine the one or more entities.

In some systems, the system further comprises a validation feedback loop configured to monitor context updates to identify usage patterns, analyze the usage patterns to determine adjustment rules for the weighted relationships, update quality metrics based on the adjustment rules, and apply the updated quality metrics to subsequent context updates, wherein the validation feedback loop comprises a learning module configured to adjust weighting parameters using at least one of reinforcement learning, Bayesian inference, or supervised learning based on validation outcomes, and wherein the validation feedback loop continuously adapts based on outcomes.

In some systems, the entity processing system is further configured to generate a first vector representation for a first modality of the multimodal data, generate a second vector representation for a second modality of the multimodal data, align the first vector representation and the second vector representation in a unified semantic space based on cross-modal correspondences, generate a unified semantic entity representing combined meaning from the first modality and the second modality.

In some systems, the cognitive processing system is configured to initially represent concepts as untyped meaning nodes connected by untyped relationship edges comprising natural language relationships, extend the untyped meaning nodes by assigning semantic classes to create typed meaning nodes, extend the untyped relationship edges by assigning semantic relationship types to create typed relationship edges, generate semantic relationship subtypes defining explicit type hierarchies with specified meaning, source types, and target types, and generate semantic meaning node subtypes with schematized attributes for capturing scalar values.

In some systems, the cognitive processing system is configured to detect contradictory relationships within the one or more semantic mappings, compare confidence scores associated with the contradictory relationships, determine priority for the contradictory relationships based on at least one of the confidence scores, temporal recency, historical patterns, user context, user preferences, domain expertise level, domain-specific rules, or semantic compatibility, and resolve the contradictory relationships by prioritizing higher-confidence or more recent relationships, or by signaling for disambiguation when multiple contradictory relationships have similar confidence scores.

In some systems, the cognitive processing system is configured to convert entities from the entity processing system into graph nodes, infer relationship types between the graph nodes based on semantic similarity and contextual patterns, calculate initial weights for the inferred relationship types using at least one of linear adjustment, exponential decay, sigmoid normalization, or Bayesian updating algorithms, validate the inferred relationship types based on context and domain constraints, and store the graph nodes and the inferred relationship types with the calculated initial weights in a cognitive storage system.

In some systems, the cognitive processing system is further configured to detect a weight adjustment to a first weighted relationship in the one or more semantic mappings, identify downstream relationships connected to the first weighted relationship, calculate propagated weight adjustments for the downstream relationships based on the weight adjustment to the first weighted relationship and a propagation factor, and apply the propagated weight adjustments to the downstream relationships.

In some systems, an entity storage system comprising the entity processing system is distributed across multiple computing nodes with partitioned or replicated storage, a cognitive storage system comprising the cognitive processing system is distributed across multiple computing nodes with partitioned or replicated storage, and the entity processing system and the cognitive processing system are configured to operate in a distributed configuration with load balancing and fault tolerance across the multiple computing nodes, wherein the distributed configuration comprises at least one of cloud-based deployment, hybrid deployment combining on-premises and cloud resources, or containerized deployment across heterogeneous computing environments.

Another method for managing a cognitive storage system may comprise analyzing a cognitive graph stored in the cognitive storage system, the cognitive graph comprising nodes and weighted relationships, to identify nodes having values below a relevance threshold, determining, for each identified node, whether to remove the node, archive the node to historical storage, or maintain the node with reduced weight, creating an optimized cognitive graph by performing the determined action for each identified node, and storing the optimized cognitive graph in the cognitive storage system, wherein the relevance threshold is based on at least one of node access frequency, relationship strength, temporal recency, or domain-specific criteria.

In some methods, the analyzing is performed periodically according to a configurable schedule, and wherein the relevance threshold is dynamically adjusted based on graph size or system performance metrics.

Another method may comprise receiving input data, performing a first similarity search against non-thought entities in an entity storage system, performing a second similarity search against thought entities in the entity storage system, assembling search context from results of the first similarity search and the second similarity search, extracting one or more entities from the search context, comparing each extracted entity to existing entities using vector similarity to identify duplicates, for each extracted entity determined to be a duplicate, associating the extracted entity with a corresponding existing entity, for each extracted entity determined not to be a duplicate, creating a new entity and storing the new entity in the entity storage system, and creating relationships between the new entity and the existing entities.

Example apparatuses, computer readable storage mediums, and systems may be configured to implement the one or more methods described above. Example apparatuses or systems may comprise one or more processors and memory storing instructions, that when executed by the one or more processors, cause the apparatuses or systems to implement the one or more methods described above. Likewise, computer readable storage mediums may store instructions that when executed cause performance of the one or more methods described above.

### General Considerations

As used herein, the terms “substantially” and/or “approximately” modify their subjects and/or values to recognize the potential presence of variations that occur in real world applications. For example, “substantially” and/or “approximately” may modify dimensions that may not be exact due to manufacturing tolerances and/or other real-world imperfections as will be understood by persons of ordinary skill in the art. For example, “substantially” and/or “approximately” may indicate such dimensions may be within a tolerance range of +/−10% unless otherwise specified in the description provided herein.

As used herein, the terms “including” and “comprising” (and all forms and tenses thereof) are open-ended terms. Thus, whenever the written description or a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein, when the phrase “at least” is used as the transition term in, for example, a preamble of a claim, it is open-ended in the same manner as the term “comprising” and “including” are open-ended. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

Although certain example apparatus, systems, methods, and articles of manufacture have been disclosed herein, the scope of coverage of this patent is not limited thereto. On the contrary, this patent covers all apparatus, systems, methods, and articles of manufacture fairly falling within the scope of the claims of this patent.

The following claims are hereby incorporated into this Detailed Description by this reference, with each claim standing on its own as a separate embodiment of the present disclosure.

What is claimed is:

1. A system comprising:
an input interface configured to receive data;
a first processing system configured to determine, based on the data, one or more entities; and
a second processing system configured to:
generate, based on the one or more entities, a probability distribution, context associated with the data, and historical interactions, one or more semantic mappings comprising nodes interconnected according to weighted relationships; and
update, based on at least one of additional data, context, or interactions, the one or more semantic mappings;
wherein the first processing system and second processing system are configured to operate coherently via an integration layer maintaining synchronized state between vector operations and graph updates to regenerate context in real-time by dynamically constructing semantic mappings.

2. The system of claim 1, wherein the second processing system is further configured to output the one or more semantic mappings to an inference engine.

3. The system of claim 2, wherein the first processing system is configured to receive, from the inference engine, a response based on the one or more semantic mappings.

4. The system of claim 1, wherein the historical interactions comprise interactions with one or more devices or systems.

5. The system of claim 1, wherein:
the first processing system is further configured to:
receive, from a source, second data;
determine, based on the second data, one or more second entities; and
the second processing system is further configured to:
adjust, based on the one or more second entities, the weighted relationships of the one or more semantic mappings; and
output the updated one or more semantic mappings.

6. The system of claim 5, wherein:
the second processing system is further configured to:
generate natural language context; and
transmit the generated natural language context to an inference engine;
the inference engine is configured to:
construct a response to the data requesting disambiguation; and
transmit the response to the source; and
the first processing system is further configured to:
receive, from the source, the second data in response to transmission of the response to the source.

7. The system of claim 6, wherein:
the inference engine is configured to iteratively request disambiguation across multiple interaction cycles until confidence levels for the one or more semantic mappings exceed a disambiguation threshold;
the second processing system is configured to preserve context across the multiple interaction cycles; and
the first processing system is configured to track cumulative clarifications from the multiple interaction cycles to refine the one or more entities.

8. The system of claim 1, wherein to determine the one or more entities, the first processing system is configured to access a storage system to receive a vector representation of the data.

9. The system of claim 1, wherein to determine the one or more entities, the first processing system is configured to:
transmit the data to a storage system; and
receive, from the storage system, entities matching the data.

10. The system of claim 1, wherein to generate the one or more semantic mappings, the second processing system is configured to create new nodes or new connections between existing nodes.

11. The system of claim 1, wherein to generate the one or more semantic mappings, the second processing system is configured to update states within a storage system representing nodes or connections.

12. The system of claim 1, wherein to update the one or more semantic mappings, the second processing system is further configured to:
calculate a decay factor based on an exponential function applied to elapsed time since last interaction with a weighted relationship;
multiply a current weight of the weighted relationship by the decay factor to generate an updated weight; and
adjust, based on temporal decay, the weighted relationships of the one or more semantic mappings by storing the updated weight, wherein the exponential function comprises a configurable decay rate parameter.

13. The system of claim 1, wherein the data comprises non-deterministic data.

14. The system of claim 1, further comprising an integration layer configured to:
translate vector operations performed by the first processing system into graph updates for the second processing system;
synchronize state between vector representations and graph representations; and
maintain coherence between the first processing system and the second processing system during real-time updates.

15. The system of claim 14, wherein the integration layer is further configured to:
detect conflicts between vector representations and graph representations during synchronization;
determine, for each detected conflict, a resolution strategy based on at least one of confidence scores, temporal recency, or source reliability; and
apply the resolution strategy to maintain consistency between the first processing system and the second processing system.

16. The system of claim 1, wherein the second processing system is further configured to:
assign a quality score to input data based on at least one of semantic coherence, contextual relevance, source reliability, or pattern matching confidence;
compare the quality score to a threshold; and
accept the input data when the quality score meets or exceeds the threshold, or signal for disambiguation when the quality score is below the threshold.

17. The system of claim 1, wherein:
the historical interactions comprise interactions from multiple users or multiple systems; and
the one or more semantic mappings are updated based on aggregated patterns across the interactions from the multiple users or the multiple systems.

18. The system of claim 1, wherein the data comprises multimodal data including at least two of text data, image data, or audio data, and wherein the first processing system is configured to generate vector representations for each modality and integrate the vector representations from multiple modalities into unified semantic entities.

19. The system of claim 18, wherein the first processing system is further configured to:
generate a first vector representation for a first modality of the multimodal data;
generate a second vector representation for a second modality of the multimodal data;
align the first vector representation and the second vector representation in a unified semantic space based on cross-modal correspondences; and
generate a unified semantic entity representing combined meaning from the first modality and the second modality.

20. The system of claim 1, wherein the weighted relationships comprise multi-dimensional weights including at least two of:
a rational dimension weight representing logical or factual strength of the relationship;
an emotional dimension weight representing affective or sentiment-based strength of the relationship; or
a temporal dimension weight representing recency or time-based relevance of the relationship.

21. The system of claim 20, wherein the rational dimension weight represents logical or factual strength of the relationship based on verified information sources or deterministic reasoning.

22. The system of claim 20, wherein the emotional dimension weight represents affective or sentiment-based strength of the relationship based on emotional context, user sentiment, or social dynamics.

23. The system of claim 20, wherein the temporal dimension weight represents recency or time-based relevance of the relationship based on elapsed time since relationship creation or last reinforcement.

24. The system of claim 1, further comprising a validation feedback loop configured to:
monitor context updates to identify usage patterns;
analyze the usage patterns to determine adjustment rules for the weighted relationships;
update quality metrics based on the adjustment rules; and
apply the updated quality metrics to subsequent context updates;
wherein the validation feedback loop comprises a learning module configured to adjust weighting parameters using at least one of reinforcement learning, Bayesian inference, or supervised learning based on validation outcomes, and wherein the validation feedback loop continuously adapts based on outcomes.

25. The system of claim 1, wherein the second processing system is configured to:
initially represent concepts as untyped meaning nodes connected by untyped relationship edges comprising natural language relationships;
extend the untyped meaning nodes by assigning semantic classes to create typed meaning nodes;
extend the untyped relationship edges by assigning semantic relationship types to create typed relationship edges;
generate semantic relationship subtypes defining explicit type hierarchies with specified meaning, source types, and target types; and
generate semantic meaning node subtypes with schematized attributes for capturing scalar values.

26. The system of claim 1, wherein the second processing system is further configured to:
detect contradictory relationships within the one or more semantic mappings;
compare confidence scores associated with the contradictory relationships;
determine priority for the contradictory relationships based on at least one of the confidence scores, temporal recency, historical patterns, user context, user preferences, domain expertise level, domain-specific rules, or semantic compatibility; and
resolve the contradictory relationships by prioritizing higher-confidence or more recent relationships, or by signaling for disambiguation when multiple contradictory relationships have similar confidence scores.

27. The system of claim 1, wherein the second processing system is configured to:
convert entities from the first processing system into graph nodes;
infer relationship types between the graph nodes based on semantic similarity and contextual patterns;
calculate initial weights for the inferred relationship types using at least one of linear adjustment, exponential decay, sigmoid normalization, or Bayesian updating algorithms;
validate the inferred relationship types based on context and domain constraints; and
store the graph nodes and the inferred relationship types with the calculated initial weights in a cognitive storage system.

28. The system of claim 1, wherein the second processing system is further configured to:
detect a weight adjustment to a first weighted relationship in the one or more semantic mappings;
identify downstream relationships connected to the first weighted relationship;
calculate propagated weight adjustments for the downstream relationships based on the weight adjustment to the first weighted relationship and a propagation factor; and
apply the propagated weight adjustments to the downstream relationships.

29. The system of claim 1, wherein:
a first storage system and the first processing system are distributed across multiple computing nodes with partitioned or replicated storage;
a second storage system and the second processing system are distributed across multiple computing nodes with partitioned or replicated storage; and
the first processing system and the second processing system are configured to operate in a distributed configuration with load balancing and fault tolerance across the multiple computing nodes;
wherein the distributed configuration comprises at least one of cloud-based deployment, hybrid deployment combining on-premises and cloud resources, or containerized deployment across heterogeneous computing environments.

30. A non-transitory computer readable storage medium storing instructions that, when executed, cause performance of:
receiving data;
determining, based on the data, one or more entities;
processing, based on a probability distribution, context associated with the data, and historical interactions, the one or more entities to form one or more semantic mappings comprising nodes interconnected according to weighted relationships; and
updating, based on at least one of additional data, context, or interactions, the one or more semantic mappings.

31. The storage medium of claim 30, wherein the updating the one or more semantic mappings comprises:
receiving, from a source, second data;
determining, based on the second data, one or more second entities;
adjusting, based on the one or more second entities, the weighted relationships of the semantic mappings; and
outputting the updated one or more semantic mappings.

32. The storage medium of claim 31, wherein the instructions, when executed, further cause performance of:
creating a response to the data requesting disambiguation; and
transmitting the response to a source, wherein receiving, from the source, the second data is in response to transmitting the response to the source.

33. The storage medium of claim 30, wherein determining, based on the data, the one or more entities comprises accessing a storage system to receive a vector representation of the data.

34. The storage medium of claim 30, wherein the data comprises non-deterministic data.

35. The storage medium of claim 30, wherein updating the one or more semantic mappings comprises adjusting, based on temporal decay, the weighted relationships of the one or more semantic mappings.

36. The storage medium of claim 30, wherein generating the one or more semantic mappings comprises creating new nodes or new connections between existing nodes.

37. An apparatus comprising:
one or more processors; and
memory storing instructions that, when executed by the one or more processors, cause:
receiving data;
determining, based on the data, one or more entities;
processing, based on a probability distribution, context associated with the data, and historical interactions, the one or more entities to form one or more semantic mappings comprising nodes interconnected according to weighted relationships; and
updating, based on at least one of additional data, context, or interactions, the one or more semantic mappings.

38. A method for managing a cognitive storage system, the method comprising:
analyzing a cognitive graph stored in a first storage system to identify nodes having values below a relevance threshold, wherein the cognitive graph comprises nodes and weighted relationships and wherein the relevance threshold is based on at least one of node access frequency, relationship strength, temporal recency, or domain-specific criteria;
determining, for each identified node, whether to remove the identified node, archive the identified node to historical storage, or maintain the identified node with reduced weight;
creating an optimized cognitive graph by performing the determined action for each identified node; and
storing the optimized cognitive graph in the first storage system.

39. The method of claim 38, wherein the analyzing is performed periodically according to a configurable schedule, and wherein the relevance threshold is dynamically adjusted based on graph size or system performance metrics.

40. A method comprising:
receiving input data;
performing a first similarity search against non-thought entities in a storage system;
performing a second similarity search against thought entities in the storage system;
assembling search context from results of the first similarity search and the second similarity search;
extracting one or more entities from the search context;
comparing each extracted entity to existing entities using vector similarity to determine duplicates;
for each extracted entity determined to be a duplicate, associating the extracted entity with a corresponding existing entity;
for each extracted entity determined not to be a duplicate, creating a new entity and storing the new entity in the storage system; and
creating relationships between the new entity and the existing entities.
